(19) United States
(12) Patent Application Publication
(10) Pub. No.: US 2018/0047254 A1
(43) Pub. Date: Feb. 15, 2018

(54) SYSTEMS AND METHODS FOR WAGERING BETS

(71) Applicant: Mark Nolan Acton, Velddrif (ZA)

(72) Inventor: Mark Nolan ACTON, Velddrif (ZA)

(21) Appl. No.: 15/548,364

(22) PCT Filed: Feb. 3, 2016
(86) PCT No.: PCT/IB16/50547

§ 371 Date: Aug. 2, 2017

(30) Foreign Application Priority Data
Feb. 3, 2015 (ZA) 2015/01067

(51) Int. Cl. G07F 17/32; G06Q 50/34

(52) U.S. Cl. CPC G07F 17/3288; G07F 17/3223; G07F 17/3209; G06Q 50/34

(57) ABSTRACT

This invention relates to computer systems, and methods for facilitating wagering. In particular, the invention related to a computer system to facilitate in the placing of bets requiring multiple selections in a bet unit by enabling the gambler to complete a single bet slip, for the placing of wagers having multiple betting combinations by using groups and rules in the selection process, to control the number of times any of these betting combinations or bet units are taken and whether any betting combinations or bet units are placed as a fixed odds bet or as a pooled bet. The computer system further enables a gambler to develop or select a module of commands capable of producing wagers automatically and further provides a system to reward the gambler for the relative correctness of his wager.

### FIELD OF THE INVENTION

This invention relates to systems and methods of wagering, particularly to games of chance requiring multiple selections in a bet.

### BACKGROUND TO THE INVENTION

Games of chance are offered on many different types of events, the most common types of events that games of chance are designed around include: a draw from a set of numbered balls, a sporting event such as a football match, a tennis or golf tournament; any race, for example, horse, greyhound or motor racing; any fantasy game such as those found in horse racing and football, and the value of a financial instrument. In essence any event that has more than one possible outcome may be used in designing a bet.

A betting operator will design a bet, around an event or series of events. A betting operator may be a Totalisator Agency where all the bets placed are combined into a pool, and then the pool net of expenses is divided amongst the winning ticket holders; or a bookmaker (sports book) that provides fixed odds on games of chance. Traditionally bookmakers offer bets on single events and combinations of events as requested by the gambler; the totalisator offers bets in a preset format on single events and multiple events for gamblers to consider. The way the bet operator allows the participant to take the bet, is either verbally, via a computerised terminal, or online using a computer, smart phone, notebook or similar device. Bets are taken by completing a bet slip, a bet slip can be either a mark sense card or an electronic display such as a computer or similar device.

The bet slip, whether it is presented on electronic displays or mark sense cards have a similar look and functionality. The bet slip, as a minimum, will require details to identify the event, the bet type, the selections, and the amount to be wagered. The selections are normally identified by a number or a name, and a check box is marked or selected to show its inclusion. The selections can be either taken in a fixed position, in a key and wheel, or in a boxed selection. Keys and wheels, and boxed methods of taking selections are only used on bet types where multiple selections of participants are required in one event (leg), these bet types are known as a Quinella, Exacta, Trifecta, Superfecta or a Triple Trio; these two methods of selection are well utilized by gamblers in these types of bets.

It is known in the industry that one of the biggest problems a gambler is faced with is what favorite (s) to leave out of a selection. Including many favorites will substantially increase the cost of a bet, and if many favorites win then the winnings would be relatively small. However, leaving out favorites greatly increases the chances of elimination, so the gambler will generally include more favorites than he would expect or want to win. Many gamblers and tipsters include more favorites in their selections than they would expect or want to win. In a Pick 6 bet, if the gambler identified five favorites he wanted covered in his wager, but only wanted to place bets having every possible combinations of 2 favorites from these 5 favorites in them, this would entail completing 10 bet slips; 10 being the number of different combinations of 2 favorites that may be made from a selection of 5 favorites. This is often time consuming and resource consuming and for larger combinations, a user may not have sufficient time at their disposal to be able to make their wagers. The same problem is encountered when considering outsiders; a gambler may identify three races where he feels an outsider has a chance of winning, but will not include three legs with outsiders as the probability of all three legs having an outsider winning is remote, and the cost is substantially more.

Another problem is that certain bets types need to be taken with a bookmaker (or sports book), and other bet types such as a Pick 3 have to be taken with a Totalisator Agency. Another problem is that in taking a wager that has many combinations, there may be certain combinations that the gambler wants to take, more times than other combinations, to do this would require completing multiple bet slips.

With so many gambling options available for gamblers to consider, it is virtually impossible for the gambler, to evaluate all the events to determine which ones he would like to place bets on. With many bet types, bet operators do not provide facilities for a gambler to enable them to set criteria that will be evaluated against many races to identify possible bets, resulting in lost revenue for bet operators.

In some conventional systems of gambling, winnings are awarded for having the absolute correct prediction. Meaning that only one bet unit of all the bet units in a wager needs to have the correct selections to win a prize. A gambler who consistently almost predicts winning combinations is penalized just as much as gamblers who consistently take wagers that have a low percentage of winning selections. Some of these gamblers would prefer a system where they are rewarded for their relative performance rather than for an absolute performance.

Other problems facing the gambling industry will be briefly mentioned. Older gamblers are not being replaced by the younger generation who are generally attracted to more dynamic types of computer applications. Present day methods of making selections in games of chance limits gamblers in using their skills and knowledge and also restricts those who may want to play a definitive “gambling system”. Gamblers are often eliminated in the earlier events in games of chance having multiple events, resulting in a loss of interest in these games of chance.

It is therefore at least an object of the present invention to address or ameliorate at least some of the issues and deficiencies described above.

### SUMMARY OF THE INVENTION

The invention is a computerized system for games of chance which require multiple participants or in other words, bet elements, to be selected to produce a complete bet unit. The computerized system aids the gambler by offering the games of chance in a format that allows the gambler to use methods that enable him to have more control in producing and the placing of wagers, and producing wagers automatically—and it provides an alternative basis to reward the gamblers. It also permits new games of chance to be introduced.

In producing wagers the gambler has more control as he may be provided with methods to, control the way selections are combined into each and every bet unit, eliminate any bet unit produced by his selection method that he would not wish to place with the bet operator, control where the bet is to be placed, control the number of times any bet unit is to be taken, and use criteria to evaluate the wager.

When a gambler produces a wager by identifying an event or series of events, selecting a bet type, and making a number of selections, this could result in multiple bet units being produced, of these bet units produced there may be one or more that the gambler wants to eliminate from the wager.

According to a first aspect of the invention, a system may be provided by the bet operator for the gambler to eliminate unwanted bet units by allowing the gambler using an input/output device, to be able to select that the individual bet units (and/or combinations of selections that produce the bet units) are displayed on the output device, and then allow the gambler to select one or more of the bet units (and/or combinations of selections that produced the bet units) for elimination when the bet is placed with the bet operator.

In an embodiment of the invention, another system to eliminate unwanted bet units may be configured to allow the gambler to select for one or more of the selected participants a command that should any of the said selected participants be combined with one or more other specified selections, then any bet unit produced including that combination of selections will be eliminated when the gambler's input is processed by the processing modules of the computer system.

In an embodiment of the invention, to control the way selections are combined into each and every bet unit, a system may be provided for the gambler using an input/output device to assign one or more selected participants to a group, and a means operable for the gambler to be able to program a rule for the group that determines the number of positions (spaces/places) in a bet unit that selections from the group are permitted to occupy. When the computer system processing module processes the gamblers input, then only bet units that conform to all the group's rules may form the wager. In an embodiment of the invention, to control the way selections are combined into each and every bet unit, a system may be provided for the gambler using an input/output device to assign one more participants to one or more groups, and a means operable for the gambler to be able to set one or more rules for each of the one or more groups that determines the number of positions (spaces/places) in a bet unit that selections from the groups are permitted to occupy. When the computer system processing module processes the gamblers input, then only bet units that conform to all the groups' rules may form the wager.

In an embodiment of the invention, for bet types such as a Triple Trio (offered by the Hong Kong Jockey Club and New Zealand Tote) which require a primary combination of multiple selections from a leg to be combined with one or more other primary combinations from other legs to produce the bet units, further comprises a system that may enable a gambler to eliminate unwanted bet units by allowing the gambler using an input/output device, to be able to select that the individual bet units (and/or combinations of primary combinations that produce the bet units) are displayed on the output device, then to be able to select one or more bet units (and/or combinations of selections that produce the bet units) for elimination when the gamblers input is processed by the computer systems processing modules.

The system may enable a gambler to eliminate unwanted bet units by allowing the gambler using an input/output device, to select for one or more of the selected participants one or more commands that should any of the said selected participants be combined with one or more other specified selections, then any bet unit produced including that combination of selections will be eliminated when the gamblers input is processed by the computer systems processing modules.

The system may enable a gambler to eliminate unwanted bet units by allowing the gambler using an input/output device, to select for one or more of the primary combinations a command that should any of the said selected primary combinations be combined with one or more other specified primary combinations, then any bet unit produced including that combination of primary combinations will be eliminated when the gamblers input is processed by the computer systems processing modules.

The system may enable a gambler to control the combinations of selections used in the primary combinations producing the bet units by allowing the gambler using an input/output device to: assign selections to a group, set rules for the group that determines the number of primary combinations having selections from the group that are permitted to be used in a bet unit, to indicate when there are two or more selections from the same event in a group (that controls the number of primary combinations having selections from its group permitted in a bet unit), whether those selections are to be counted individually or as a unit (with anyone or more of the other selections from the same event) within a primary combination, so that it is determinable when each bet unit is being evaluated whether the number of primary combinations with selections or units of selections from a group, is permitted in a bet unit by the group's rules. When the computer system processing module processes the gamblers input, then only bet units that conform to all the groups' rules would be produced.

The system may enable a gambler to control the combinations of selections used in the primary combinations producing the bet units by allowing the gambler using an input/output device to: assign selections to one or more groups, set rules for each group that determines the number of primary combinations in a bet unit permitted to have selections from its group, whether those selections are to be counted individually or as a unit (with anyone or more of the other selections from the same event) within a primary combination, so that it may be determinable when each bet unit is being evaluated by the group's rules, whether the number of primary combinations having selections or units of selections from its group in the bet unit, is permitted by the group's rules. When the computer system processing module processes the gamblers input, then only bet units that conform to all the groups' rules would be produced.

The system may enable a gambler to control the combinations of the primary combinations used in producing the bet units by allowing the gambler using an input/output device to: display the primary combinations produced by his selections and assign primary combinations in at least two events to a group, set rules for the group that determines the number of primary combinations from the said group permitted in a bet unit. When the computer system processing module processes the gamblers input, then only bet units that conform to all the groups' rules would be produced.

The system may enable a gambler to control the combinations of the primary combinations used in producing the bet units by allowing the gambler using an input/output device to: display the primary combinations and assign primary combinations to one or more groups, set rules for each group of primary combinations that determines the number of primary combinations from its group permitted to be used in a bet unit. When the computer system processing module processes the gamblers input, then only bet units that conform to all the groups' rules would be produced.

In using groups, a group may include one or more selections, a group can cover one or more positions in a bet unit, and a selection may be assigned to one or more groups.

In using rules in the above, when reference is made to a number of selections or primary combinations, this could also imply a range of the number of selections/primary combinations from the group that could be used in every bet unit, it could further mean that two or more different numbers and/or ranges of selections/primary combinations that could be required to be used in every bet unit.

In an embodiment of the invention, the gambler using an input/output device may indicate for any selection or group of selections, whether any bet unit containing that selection or one of the selections from the group, is to be taken as a pooled and/or as a fixed odds bet and the number of times any bet unit is to be taken. In referring to the number of times any bet unit is to be taken, it also implies that it is able to taken as a fraction of the cost of a bet unit, for example a bet unit could be taken 10 times or at half the cost of a bet unit.

In an embodiment of the invention, for any selection or group of selections the gambler may be able to select a command that should certain criteria be meet at a specified time or during any specified period of time before the betting is closed, that a selection or selections may be removed from the group, get transferred to another group, change the rules for any group, remove other selections from groups, transfer other selections to another groups, add selections to groups, change or select whether any bet unit may be taken as a pooled bet and/or fixed odds bet and the number of times any bet unit is to be taken.

The inventions use of groups and rules as a method of producing wagers opens up possibilities for designing new games of chance and modifying present day games of chance. In present day games of chance where the gambler has to select either participants, the outcome of events or gaming tokens to produce a wager, the use of groups and rules allows these games to be adapted into new games of chance by enabling the bet operator to assign the possible selections to one or more groups, the gambler would then only have to set the rules for the group or groups to produce a wager.

The previously mentioned manual procedures to produce a wager could be replicated in a module of commands that would be processed by the computer processing module to produce wagers or reports automatically. A module of commands could be developed by the gambler, or by the bet operator using an input/output device and saved to the computer's memory banks. A module of commands could aid the gambler in playing games of chance by, displaying customized reports relating to the games of chance, producing wagers without any input from the gambler and as a data analysis tool on games of chance that have already taken place.

In an embodiment of the invention, to display customized information relating to games of chance the gambler may develop a module of commands using an input/output device and may select from a menu presented thereto by the system one or more of: a category of games of chance such as either horse racing (hurdles) or football pools, one or more groups and then one or more commands with adjustable criteria for each group that would be capable of evaluating the possible selections in all the events in the chosen category of games of chance and if one or more of the criteria's condition is met for any group then to assign the one or more participants to the said group (rules could be set for the group at this stage but only need to be set when the group is selected to be used to produce a wager, rules if set would have no effect on the selections displayed for the group); the gambler would then be able to save the module of commands to the computer's memory banks. When the gambler needs to evaluate the events in games of chance he would select: the module of commands, the events to be evaluated, the content and format of the information to be displayed, the requested information would then be displayed on an output device in the required format.

In an embodiment of the invention, to develop a module of commands that would produce bet units automatically, the gambler using an input/output device would: select a category of games of chance, select a bet type, select a group structure of one or more groups (possibly some of the groups set up for information purposes in the previous paragraph), select commands for each group that evaluates the possible selections in all events or those events meeting selected criteria for the bet type selected and then assigns those selections meeting the criteria to the respective groups, set rules for each group that determines a range of the number of positions in a bet unit that selections from the group are permitted to occupy in producing bet units, and save the module of commands. The gambler would then be able to access the module of commands via the computerized network for further development or use. The module of commands at this stage is capable of producing bet units for any chosen event (s).

For bet types where multiple selections in an event are required to produce a primary combination which is then combined with other primary combinations from other events to produce a bet unit (such as the Triple Trio used in horse racing), in developing a module of commands the procedures mentioned in the previous paragraphs are used to produce the primary combinations, to control the bet units produced using groups, two methods may be employed. In the first method the commands may control the number of primary combinations having selections from a group that are permitted to be used in a bet unit, in this method the system may enable the gambler to select commands that make selections from any of the selected participants (those selected to be used to produce the primary combinations) and may assign it to one or more groups, and then set rules for each group that determines the range of the number of primary combinations with selections from its group that are permitted to be included in a bet unit. If a group (used to control the number of primary combinations with selections from its group that are to be used in producing the bet units), has two or more selections from the same event, then a command needs to be included in the module of commands that instructs whether those selections are to be counted individually or as a unit (with anyone or more of the other selections from the same event) within a primary combination, so that it may be determinable when each bet unit is being evaluated by the group's rules, whether the number of primary combinations (having selections or units of selections from its group) in the bet unit, is permitted by the group's rules. In the second method, the commands control the number of primary combinations from a group that are permitted to be used in a bet unit. In this method, the gambler may select commands that, analyze the primary combinations produced and assigns those primary combinations meeting certain criteria to one or more groups, and then sets rules for each group that determine the number of primary combinations from its group that are permitted to be used in producing the bet units. A means operable to save the module of commands. The module of commands at this stage is capable of producing bet units for any chosen events.

When a module of commands is capable of producing bet units as described in the previous paragraphs, it may be capable of evaluating both forthcoming and past events.

In an embodiment of the invention, the gambler using an input/output device may be enabled to: select a number of forthcoming events, enter wagering information such as the amount to bet, the maximum that may be bet, or the fraction of the bet cost to be taken, the number of times the bet is to be taken and whether it is to be taken as a pooled wager and/or fixed odds wager, whether the gambler needs to approve the bet before it is placed, whether the gambler is to be advised of the race results, how the wager is to be funded, or when the bet is to be placed; and upon the selected forthcoming events being opened for betting, evaluating the events and handling any bets produced as instructed by the said module of commands.

In an embodiment of the invention, the gambler using an input/output device may be enabled to select a number of events which have already taken place; when the module of commands has evaluated these past events and produced bet units, then these bet units and/or wagers may be displayed with the race results and dividends declared for information purposes.

In the description in the previous paragraphs, when developing the module of commands the gambler made certain choices such as: the bet type, the number of groups, the commands that made selections for the groups, and what the rules for the groups would be set at, these choices made by the gambler could be made by commands selected by the gambler. Commands could also be selected to control the placement of the bet, evaluate criteria and adjust the bet.

In an embodiment of the invention, the gambler using an input/output device may be enabled to select commands that would evaluate the games of chance and then select a bet type, a number of groups, rules for the groups and commands that assign selections to groups.

In an embodiment of the invention, the gambler using an input/output device may be enabled to select commands that would evaluate the other groups selections and/or rules and then select one of multiple preselected commands to be used to assign participants to the said group.

In an embodiment of the invention, the gambler using an input/output device may be enabled to select commands that would evaluate the other groups selections and/or other groups rules and set the rules for the said group.

In an embodiment of the invention, the gambler using an input/output device may be enabled to select commands that determines whether a selection meets certain criteria, and if so whether any bet unit including the said selection may be to be taken as a pooled bet and/or as a fixed odds bet, and the number of times any bet units are to be taken.

In an embodiment of the invention, the gambler using an input/output device may be enabled to select commands that evaluated the games of chance, at a specified time or over a period of time to determine if any criteria's condition is met.

In an embodiment of the invention, the gambler using an input/output device may be enabled to select commands that determine if a criteria's condition is met, whether the selection is removed from the group, transferred to another group, other selections are remove from groups or transferred to other groups, new selections are assigned to groups, or the rules for any group are changed.

In an embodiment of the invention, the gambler using an input/output device may be enabled to select commands to evaluate data such as track or field conditions, the race distance, the race grade, the number of runners, the jockeys, the trainers, the participants speed ratings, odds or past performances and the gamblers account details.

In an embodiment of the invention, the gambler using an input/output device selects commands that may include criteria that are adjustable.

In an embodiment of the invention, the bet operator or another entity (sponsor or tipster) may develop a module of commands which the gambler could then select and if required, to add or change commands and adjust criteria.

In an embodiment of the invention, modules of commands to automatically produce wagers or reports could also be developed by a computer analyzing a gambler's betting patterns and selection criteria, then develop a module of commands for the gambler to use that could produce reports or wagers.

In producing the bet units using the invention, the gambler may be able to control the selections that are included in each and every bet unit; the invention therefore provides a system for rewarding the gambler for his correct selections in each and every bet unit, relative to the correctness of all the gamblers selections. The reward offered would be a fraction of the pool calculated by dividing the gambler's total number of correct selections (or score) in ever bet unit of his wager, by the tally of all the gamblers total number of correct selections (or score) in every bet unit. This method of rewarding gamblers will be referred to as relative performance gambling. The method of rewarding a gambler in relative performance gambling does not necessarily need to replace traditional methods of rewarding a gambler, both methods of rewarding the gambler could be implemented into a computer system each with its own pool, the gambler would then be able to place his wager in either or both of the pools.

Different methods may be employed in relative performance gambling to vary the amount of the reward a gambler may receive. These methods include offering a greater reward for having many legs with correct predictions in a bet unit, offering a greater reward for predicting outsiders (or lesser ranked horses) to win than for predicting favorites to win, to eliminate a present percentage or preset number of the gamblers with the lowest score or having less than a certain percentage of correct selections, or those with a score less than a certain amount. For each of these methods a number of pools could be provide, where each would have a different risk and reward level; each risk and reward level would eliminate a different percentage or number of gamblers, or have different point structures to reward correct selections. The gambler could select one or more of the pools (in addition to the traditional pool) to submit his wager into.

In relative performance gambling it may be not required to have a winning selection in ever leg to win a prize, therefore a variation to the game of chance would be to allow the gambler to make selections only in those legs he wanted to.

According to another aspect of the invention, there is provided a system for use in a system of gambling, said system comprising one or more of the following:
one or means operable to enable a gambler to produce a bet;
one or more means operable to enable a gambler to submit the bet into a relative performance pool;
a means operable to receive the results of events in games of chance;
a means operable to determine the score for each gambler by evaluating the gambler's bet units against the race results;
a means operable to determine the reward each gambler shall receive, the said reward being a fraction of the pool, the said fraction being the score of the gambler divided by the total score for all the gamblers;
a means operable to distribute the said reward to the gambler.

To determine the score for each gambler may comprise summing the number of correct selections in each bet unit of the bet. To determine the score for each gambler, may further comprises summing of the values awarded for the correct selections in each bet unit of the bet, where the values awarded for the correct selections increases for subsequent correct selections in each bet unit. Moreover, to determine the score for each gambler, may further comprise summing of the values awarded for the correct selections in each bet unit of the bet, where the values awarded for the correct selections are correlated to the odds of the participants. Yet further, to determine the score for each gambler, may further comprise summing of the values awarded for the correct selections in each bet unit of the bet, where the values awarded for the correct selections are correlated to the rankings of the participants.

The system may further comprise one or more of the following:
a means of eliminating a preset percentage of the gamblers with the lowest score;
a means of eliminating those gamblers that have less than a specified percentage of correct selections;

a means of eliminating those gamblers whose score is less than a specified value.

The gambler submit the bet or wager into the relative performance pool further comprises, one or more means operable to enable a gambler to submit the bet in one or more pools, where each pool may have differing criteria to determine the percentage or number of gamblers to be eliminated.

Each pool may have differing criteria to determine which of the gamblers are to be eliminated, comprising criteria that determine which gamblers are eliminated based on the percentage or number of correct selections or the score of the gamblers.

To determine the score for each gambler may further comprise, in financial games of chance, when the financial instrument's performance is measure as a percentage based on its change in value over a period of time, then the score of the gambler represents the average of all the percentage changes in the value for the period of his selected financial instruments for the time period selected, less the average of the score for all the gamblers.

The reward may be a fraction of the pool, further comprises in financial games of chance when the financial instrument's performance is measure as a percentage based on its change in value over a period of time, then the reward the gambler will receive will be the product of the score as a percentage and the amount the gambler had invested.

According to another aspect of the invention, there is provided a computer system configured for use in games of chance including a user interface to facilitate the offering and placement of bets, the computer system comprising:
a database or memory element, wherein a sector of a memory element stores computer processing programs, and
a processing module to execute the computer processing programs, wherein the computer processing module is configured to perform the following operations:
displaying information relating to games of chance;
receiving via the network from the gamblers using one or more input devices betting details including:
a selection of a bet type for an event or number of events used in a game of chance;
a selection of a number of the participants from the event or events that would produce at least one bet unit:
an instruction as to which groups the selected participants have been assigned to;
a rule for each group determining the range of the number of positions in a bet unit that selections from its group are permitted to be in;
a command that if a bet unit contains a specified selection with another specified selection then the bet unit is eliminated;
an instruction to display the bet units or the combinations producing the bet units;
a selection of any bet units or combinations producing the bet units that are to be eliminated on placing the bet;
an instruction whether any bet unit including a specified selection is to be taken as a pooled bet and/or as a fixed odds bet and/or the number of times any bet unit is to be taken;
a command for a selection or a group of selections that should it meet certain criteria at a specified time or during any period of time before the betting is closed, that it may be removed from the group, get transferred to another group, change the rules for any group, remove other selections from groups, transfer other selections to another groups, and/or add selections to groups before the bet is placed
an instruction on whether the bet is funded by cash, card or account;
an instruction to place any bet units not eliminated with the bet operator;
issuing of a bet slip to the gambler;
storing the gamblers betting details in a data base in the memory element of the computer system.

The system may require multiple selections in a leg or in other words an event in a game of chance, or a sub-event in an event such as a leg in a horse race, to produce a primary combination which is then combined with one or more other primary combinations from other legs to produce the bet units, wherein the system is configured for:
receiving via the network from gamblers using one or more input devices betting details including:
a selection of participants assigned to one or more groups in each leg and a rule for each group that determines the range of the number of selections from each group permitted in a primary combination;
a selection of participants assigned to one or more groups with an indication for each selection whether it is to be considered individually or as a unit with one or more other specified selections from the same primary combination in determining the number of primary combinations in a bet unit permitted to have selections from the said group and a rule for each group that determines the range of the number of primary combinations containing one or more of the said groups selections that are permitted in a bet unit;
an instruction to display the primary combinations produced;
a selection of primary combinations assigned to one or more groups and a rule for each group that determines the range of the number of its primary combinations permitted in a bet unit;
a command that if any bet unit contains a specified selection with one or more other specified selections then the bet unit is eliminated;
a command that if any bet unit contains a specified primary combination with one or more other specified primary combinations then the bet unit is eliminated.

The system may be configured for receiving via the network from the gamblers using one or more input devices betting details including:
a selection of at least two of the participants in the game of chance that would produce at least one bet unit;
an instruction as to which groups the selected participants have been assigned to;
further comprising, receiving via the network from an entity other than the gambler using one or more input devices details including:
a selection of at least two of the participants in the game of chance that would produce at least one bet unit;
an instruction as to which groups the selected participants have been assigned to.

According to yet another aspect of the invention, there is provided a computer system configured for use in games of chance including a user interface to facilitate the development of a module of commands to perform automated functions on behalf of the gambler, the computer system comprising:
a sector of a memory element storing computer processing programs, and
a processing module to execute the computer processing programs, wherein the computer processing module is configured to perform the following operations:
   displaying information relating to games of chance;
   receiving via the network from the gamblers using one or more input devices details including:
   a selection of a category of games of chance;
   a selection of one or more groups;
   a selection of a command for each group to evaluate all participants and assign those participants meeting the criteria's conditions to the group;
   a selection of those groups for which the group's selected participants must be displayed and the format in which to display the information;
   a selection of a bet type;
   a rule for each group that determines the range of the number of positions in a bet unit that selections from its group are permitted to be in;
   a selection of a command that would evaluate a category of games of chance and enable selection of a bet type, commands, group structure and/or groups rules;
   a selection of a command that would evaluate one or more other groups selections and/or rules in determining what participants to assign to the said group;
   a selection of a command that would evaluate one or more other groups selections and/or rules in determining the rules for the said group;
   a selection of a command that determines if a condition is met at a specified time or during any period of time prior to the betting closing whether the selection is removed from the group or transferred to another group, one or more other selections are remove from groups or transferred to another group, one or more new selections are assigned to groups, and/or the rules for any group are changed;
   a selection of a command that determines if a selection meets certain criteria whether any bet unit including the said selection is to be taken as a pooled bet and/or as a fixed odd bet and the number of times any bet units can be taken;
an instruction to save the said module of commands;
displaying on a user interface in the requested format those selections from those groups previously identified for the events selected by the gambler;
storing the gamblers betting details in a data base in the memory element of the computer system.

When the system requires multiple selections in a leg to produce a primary combination which is combined with other primary combinations from other legs to produce a bet unit, the system may be further configured for:
receiving via the network from gamblers using one or more input devices details including:
a selection of a command that assigns participants to groups that produce primary combinations;
a selection of a command that assigns participants to groups that control what combinations of primary combinations are used in constructing bet units;
rules for groups that produce primary combinations that determine a range of the number of places in the primary combination that selections from a group are permitted to occupy in constructing primary combinations;
rules for groups that produce bet units that determine the range of the number of primary combinations with selections from that group permitted in a bet unit;
an instruction whether the selections in groups producing bet units are to be considered individually or as a unit with one or more other specified selections in the same leg from the group, when the selections in each primary combination of a bet unit are being evaluated by the groups rules to determine whether the number of primary combinations in a bet unit with the group's selections is permitted.

The system may be further configured for:
receiving from the gambler a selection of a number of forthcoming events;
receiving from the gambler wagering information such as either the amount to be bet or the maximum that may be bet or the fraction of the bet cost to be taken, the number of times the bet is to be taken and/or whether it is to be taken as a pooled wager and/or fixed odds wager, whether the gambler needs to approve the bet before it is placed or is it placed automatically, whether the gambler is to be advised of the race results, how the wager is to be funded, when the games of chance are to be evaluated and when the bet is to be placed; and
upon the selected forthcoming events being opened for betting, evaluating the events and handling any bets produced as programmed in said module of commands.

The system may be configured for:
receiving from the gambler a selection of events which have already taken place;
evaluating the past events and producing bets by the module of commands; and
displaying any bets produced and the race results and dividends for the games of chance where there were bets produced.

The gambler may select commands with criteria, the system may be further configured for selecting commands to evaluate data such as track or field conditions, the race distance, the race grade, the number of runners, the jockeys, the trainers, the participants speed ratings, odds or past performances and the gambler's account details.

The system may be further configured for allowing the gambler to program the command that if any selection meets a criteria's condition then any bet unit including that selection is to be taken as a pooled bet and/or as a fixed odd bet and the number of times any said bet units are to be taken.

The gambler may select commands further comprises selecting commands having criteria that are adjustable by the gambler.

Wherein the system may be configured to allow the bet operator or another entity to develop a module of commands for the gambler to choose and utilize.

According to another aspect of the invention, there is provided a computer system configured for use in game of chance including a user interface to facilitate the rewarding of gamblers, the computer system comprising:
a sector of a memory element storing computer processing programs, and
a processing module to execute the computer processing programs, wherein the computer processing module is configured to perform the following operations:
displaying information relating to games of chance;
receiving via the network from the gamblers using one or more input devices betting details including:
   a selection of participants in a game of chance to produce a complete bet;
   an instruction to submit the bet into the relative performance pool;
   receiving via the administrators module the race results;
   evaluating each gamblers bet units against the race results to determine a score for each gambler;
   computing the reward for each gambler, the reward being the a fraction of the relative performance pool, the said fraction being the score of the gambler divided by the total score for all the gamblers;
   distributing the reward to the gamblers by either crediting a gambler's account or by issuing cash via the networked computer system through a cash dispensing machine or a representative for the bet operator.

The system may be configured to determine the score for each gambler, wherein the determining may comprise summing the number of correct selections in each bet unit of the bet.

Wherein to determine the score for each gambler, the system may be further configured to sum the values awarded for the correct selections in each bet unit of the bet, where the values awarded for the correct selections increases for subsequent correct selections in each bet unit of the bet.

The system may be configured to determine the score for each gambler, further comprises summing of the values awarded in each bet unit of the bet, where the values awarded for the correct selections are correlated to the odds of the participants.

The system may be configured to summing of the values awarded in each bet unit of the bet to determine the user score, where the values awarded for the correct selections are correlated to the rankings of the participants.

Wherein to determine the score for each gambler, the system may be configured, in financial games of chance when the financial instrument's performance is measure as a percentage based on its change in value over a period of time, to generate a score of the gambler which h represents the average of all the percentage changes in the value for the period of his selected financial instruments, less the average of the score for all the gamblers.

The reward may be a fraction of the pool, further comprises in financial games of chance when the financial instrument's performance is measure as a percentage based on its change in value over a period of time, then the reward the gambler will receive will be the product of the score as a percentage and the amount the gambler had invested.

The system may comprise:
a means of eliminating a preset percentage of the gamblers with the lowest score;
a means of eliminating a number of gamblers that have less than a specified percentage of correct selections;
a means of eliminating a number of gamblers whose score is less than a specified value.

The gambler may submit the bet into the relative performance pool, the system may further comprise one or more means operable to enable a gambler to place the bet in one or more pools, where each pool has differing criteria to determine the percentage or number of gamblers to be eliminated.

Each pool may have differing criteria to determine which of the gamblers are to be eliminated, comprising criteria that determine which gamblers are eliminated based on the percentage number of correct selections or the score of the gamblers.

According to another aspect of the invention, there is provided a system for facilitating wagering, the system comprising:
a database storing data; and
a processor configured to:
   allocate one or more bet elements to one or more groups and storing the allocations in the database;
   apply one or more criteria to one or both of the selected one or more bet elements and the one or more groups to generate one or more bet units which conform substantially to the one or more criteria; and
   generate a wager comprising at least some of the one or more conforming bet units.

It will be understood that the system effectively employs the usage of group selections and criteria to conserve processing resources and a users time by generating wagers and/or bet units automatically.

The processor may be configured to:
receive a selection of a bet type for one or more events having uncertain outcomes;
receive a selection of bet elements, wherein the bet elements are associated with the one or more events;
receive information indicative of the allocation of the received selection of bet elements to the one or more groups;
receive a selection of one or more criteria to apply to the one or more groups, wherein the one or more criteria comprise one or more rules for application to the one or more groups;
apply the one or more rules to the one or more groups to generate one or more bet units in accordance with the selected bet type, wherein the generated bet units conform substantially to or are in accordance with the one or more rules;
prompt a user for a selection of the one or more generated bet units;
receive a selection of the one or more generated bet units from a user; and
generate a wager comprising the selected one or more generated bet units.

The one or more rules applied by the processor may enable the processor to control the number of occurrences, of a bet element, from a group, in a bet unit.

The processor may be configured to:
receive a selection of, or determine one or more criteria to apply to the bet elements, wherein the one or more criteria comprises one or more commands;
apply one or more commands to one or more of the selected bet elements, and/or groups, and generate one or more bet units which conform substantially to or are in accordance with the one or more commands; and
generate a wager comprising the one or more conforming bet units.

The one or more commands may be applied by the processor to enable the processor to control the occurrence of a bet unit in a wager.

The processor may be configured to:
receive a selection of a plurality of bet elements, wherein the bet elements are associated with a plurality of events;
receive information indicative of the allocation of the received selection of bet elements to the one or more groups;
receive a selection of one or more criteria to apply to the one or more groups, wherein the one or more criteria comprise at least one or more rules for application to the one or more groups;
store the rules in the database; and
apply the one or more rules to the one or more groups to generate one or more primary combinations in each event of the plurality of events, wherein each primary combination comprises multiple bet elements for the event which substantially conform to the one or more rules.

The processor may further be configured to:
generate a bet unit which comprises a primary combination in each of the plurality of events; and
generate a wager comprising one or more bet units.

The processor may be configured to:
prompt a user for a selection of the one or both of the primary combinations and the generated bet units;
receive a selection of the one or both of the primary combinations and the generated bet units from a user; and
generate a wager comprising the selected one or both of the primary combinations and the generated bet units.

The one or more rules applied by the processor may enable the processor to control one or more of:
the number of occurrences of bet elements, from a group, in a primary combination;
the number of occurrences of primary combinations in a bet unit permitted to have bet elements from a group; and
the number of occurrences of primary combinations from a group comprising primary combinations to be included in a bet unit, wherein the user selects the primary combinations to be allocated to the group.

The processor may be configured to enable a user to select, when a bet element selected is assigned to a group, whether the one or more rules associated with the group is to consider of the bet elements individually or as a unit with one or more other bet elements in the same primary combination, when determining the number of primary combinations in a bet unit permitted to have selections from a group.

The one or more criteria may comprise one or more commands, wherein the processor is configured to apply the one or more commands to the one or more of the selected bet elements, groups, bet units, and primary combinations to generate bet units or a wager conforming substantially to the one or more commands.

The one or more commands applied by the processor are suitable to control the occurrence of a bet unit in a wager.

The one or more criteria may comprise one or more commands, wherein the processor is configured to receive and execute a command for any bet element or any group of bet elements, wherein upon execution of the command the processor is configured to determine that should certain parameters be meet at a specified time or during any specified time period before a close of a betting window associated with a wager, the processor if configured to remove bet element/s from the group, transfer bet element/s to another group, change the rules for any group, remove other bet element/s from groups, transfer other bet elements to other groups, add bet element/s to groups, change or select whether any bet unit is taken as a pooled bet and/or fixed odds bet and the number of times any bet units are to be taken.

The processor may further be configured to:
receive one or more of historic data indicative of outcomes of one or more events, previous selections of criteria, previous selections of bet elements, and bet units:
use the received historic data to generate a module of commands; and
use the module of commands to automatically allocate the bet elements, apply the one or more criteria, and generate the wager.

The system may comprise a bet operator interaction module operable to interface the system with a bet operator such that the generated wager is transferred to the bet operator via the bet operator interaction module to be placed by the bet operator.

The system may comprise a bet operator interaction module operable to interface the system with a bet operator such that the generated wager is transferred to the bet operator via the bet operator interaction module to be placed by the bet operator.

The processor may be configured to:
receive a selection of a category of games of chance;
receive a selection of one or more groups;
receive a selection of criteria in the form of command/s for each group to evaluate all bet elements in the form of participants in one or more events in the selected game of chance and assign those participants substantially in conformity or in accordance with the selected commands to the group;
receive a selection of those groups for which the group's selected participants must be displayed to a user and the format in which to display the information;
receive a selection of a bet type;
receive a selection of criteria in the form of rule/s for each group that determines the range of the number of positions in a bet unit that participants from its group are permitted to be in;
receive a selection of a command that would evaluate a category of games of chance and enable selection of a bet type, commands, group structure and/or groups rules;
receive a selection of a command that would evaluate one or more other groups selection and/or rules in determining what participants to assign to the said group;
receive a selection of a command that would evaluate one or more other groups selections and/or rules in determining the rules for the said group;
receive a selection of a command that determines if a condition is met at a specified time or during any period of time prior to the betting closing whether the selection is removed from the group or transferred to another group, one or more other selections are remove from groups or transferred to another group, one or more new selections are assigned to groups, and/or the rules for any group are changed;
receive a selection of a command that determines if a selection meets certain requirements whether any bet unit including the said selection is to be taken as a pooled bet and/or as a fixed odd bet and the number of times any bet units can be taken;
receive an instruction to store one or more of the selected commands in a module of commands;
store the module of commands in the database; and
operate the module of commands mule to generate a wager which substantially conforms or is in accordance with the commands stored in the module of commands.

According to another aspect of the invention, there is provided a method of operating a system for facilitating wagering, the method comprising:
maintaining a database;
allocating one or more bet elements to one or more groups and storing the allocations in the database;
applying one or more criteria to one or both of the selected one or more bet elements and the one or more groups to generate one or more bet units which conform substantially to the one or more criteria; and
generating a wager comprising at least some of the one or more conforming bet units.

The method may comprise:
receiving a selection of a bet type of one or more events having uncertain outcomes;
receiving a selection of bet elements, wherein the bet elements are associated with the one or more events;
receiving information indicative of the allocation of the received selection of bet elements to the one or more groups;
receiving a selection of one or more criteria to apply to the one or more groups, wherein the one or more criteria comprise one or more rules for application to the one or more groups; applying the one or more rules to the one or more groups to generate one or more bet units in accordance with the selected bet type and storing the generated bet units in a database, wherein the one or more generated bet units conform substantially to the one or more rules;
prompting a user via an input/output device for a selection of the one or more generated bet units;
receiving a selection of the one or more generated bet units from a user; and
generating a wager comprising the selected one or more generated bet units.

The method may comprise:
receiving a selection of, or determining one or more criteria to apply to the bet elements, wherein the one or more criteria comprises one or more commands;
applying one or more commands to one or more of the selected bet elements, and/or groups, and generating one or more bet units which conform substantially to the one or more commands; and
generating a wager comprising the one or more conforming bet units.

The method may further comprise:
receiving a selection of a plurality of bet elements, wherein the bet elements are associated with a plurality of events;
receiving information indicative of the allocation of the received selection of bet elements to the one or more groups;
receiving a selection of one or more criteria to apply to the one or more groups, wherein the one or more criteria comprise at least one or more rules for application to the one or more groups; and
applying the one or more rules to the one or more groups to generate one or more primary combinations in each event of the plurality of events, wherein each primary combination comprises multiple bet elements for the event which substantially conform to the one or more rules.

The method may comprise:
generating a bet unit which comprises a primary combination in each of the plurality of events; and
generating a wager comprising one or more bet units.

The method may comprise:
prompting a user for a selection of the one or both of the primary combinations and the generated bet units;
receiving a selection of the one or both of the primary combinations and the generated bet units from a user; and
generating a wager comprising the selected one or both of the primary combinations and the generated bet units.

The method may further comprise:
receiving one or more of historic data indicative of outcomes of one or more events, previous selections of criteria, previous selections of bet elements, and bet units:
using the received historic data to generate a module of commands; and
using the module of commands to automatically allocate the bet elements, apply the one or more criteria, and generate the wager.

The method may comprise:
receiving a selection of criteria from a user, wherein the criteria comprises one or more rules and commands;
storing the received selection of criteria in the database in a module of commands; and using the module of commands to automatically generate the wager.

The method may comprise the steps of:
receiving, from a user, a selection of a category of games of chance;
receiving, from a user, a selection of one or more groups;
receiving, from a user, a selection of criteria in the form of command/s for each group to evaluate all bet elements in the form of participants one or more events in the selected game of chance and assign those participants substantially in conformity or in accordance with the selected commands to the group;
receiving, from a user, a selection of those groups for which the group's selected participants must be displayed to a user and the format in which to display the information;
receiving, from a user, a selection of a bet type;
receiving, from a user, a selection of criteria in the form of rule/s for each group that determines the range of the number of positions in a bet unit that participants from its group are permitted to be in,
receiving, from a user, a selection of a command that would evaluate a category of games of chance and enable selection of a bet type, commands, group structure and/or groups rules;
receiving, from a user, a selection of a command that would evaluate one or more other groups selections and/or rules in determining what participants to assign to the said group;
receiving, from a user, a selection of a command that would evaluate one or more other groups selections and/or rules in determining the rules for the said group;
receiving, from a user, a selection of a command that determines if a condition is met at a specified time or during any period of time prior to the betting closing whether the selection is removed from the group or transferred to another group, one or more other selections are remove from groups or transferred to another group, one or more new selections are assigned to groups, and/or the rules for any group are changed;
receiving, from a user, a selection of a command that determines if a selection meets certain requirements whether any bet unit including the said selection is to be taken as a pooled bet and/or as a fixed odd bet and the number of times any bet units can be taken;
receiving, from a user, an instruction to store one or more of the selected commands in a module of commands;
   storing the module of commands in the database; and
operating the module of commands module to generate a wager which substantially conforms or is in accordance with the commands stored in the module of commands.

The method may comprise prompting the user or gambler for the selection and/or data received thereby. In one example embodiment, the method may comprise providing the user with data to be selected thereby, for example, by way of a drop down menu comprising a plurality of options for each type of selection received by the system.

According to yet another aspect of the invention, there is provided a non-transitory computer readable medium comprising a set of computer executable instructions which when operated by a computer system, causes the same to perform the method as described above and herein.

According to another aspect of the invention, there is provided a system for use in wagering, the system comprising:
a database storing data; and
a processor configured to:
   receive a user selection of a category of a game of chance comprising one or more events via a suitable electronic input/output device;
   receive a user selection of one or more groups and storing information associated therewith in the database;
   receive a user selection of commands for each selected group;
   use the selected commands to generate a module of commands and store the same in the database, wherein the module of commands is configured to apply some or all of the selected commands, wherein the application of the commands by the module of commands causes the processor to evaluate one or both of events and bet elements in the form of participants in all or some events relating to the game of chance, and if one or more of the participants of the events are substantially in conformity or accordance with the selected commands, assign the one or more participants to the respective group/s; and
   receive from the user a selection of events for the module of commands to evaluate.

The processor may be configured to:
receive a selection of a bet type from the user;
receive a selection from the user of one or both of an existing group or a new group;
receive a selection from the user of a set rules for each selected group that determines a range of the number of positions in a bet unit that selections from a group are permitted to occupy in producing bet units; and
generating a wager automatically based on the commands applied by the module of commands and selected rules.

According to another aspect of the invention, there is provided a computer system for wagering, the system comprising:
a memory element storing data; and
a processor comprising a user interface module to facilitate the offering and placement of bets, the processor being configured to:
display information relating to games of chance;
receive via a communication network from users using one or more input devices betting details including:
   a selection of a bet type for an event or number of events used in a game of chance;
   a selection of a number of the participants from the event or events that would produce at least one bet unit;
   an instruction as to which groups the selected participants have been assigned to;
   a rule for each group determining the range of the number of positions in a bet unit that selections from its group are permitted to be in;
   a command that if a bet unit contains a specified selection with another specified selection then the bet unit is eliminated;
   an instruction to display the bet units or the combinations producing the bet units;
   a selection of any bet units or combinations producing the bet units that are to be eliminated on placing the bet;
   an instruction whether any bet unit including a specified bet element is to be taken as a pooled bet and/or as a fixed odds bet and/or the number of times any bet unit is to be taken;
   a command for a bet element or a group of bet element that should it meet certain criteria at a specified time or during any period of time before the betting is closed, that it may be removed from the group, get transferred to another group, change the rules for any group, remove other selections from groups, transfer other selections to another groups, and/or add selections to groups before the bet is placed;
   an instruction on whether the bet is funded by cash, card or account;
   an instruction to place any bet units not eliminated with the bet operator; generate and issue of a bet slip to the user;
storing the users betting details in a data base in the memory element of the computer system.

The method may comprise placing the bet with a bet operator.

According to yet another aspect of the invention, there is provided a computer system for wagering comprising:
a database storing data; and
a processor configured to:
   display information relating to games of chance to a user via a suitable input/output device;
   receive, via a communications network, from user's input/output devices:
   a selection of a category of games of chance;
   a selection of one or more groups;
   a selection of a command for each group to evaluate all bet elements in the form of participants in one or more events in the selected game of chance and assign those participants substantially in conformity or in accordance with the selected commands to the group;
   a selection of those groups for which the group's selected participants must be displayed and the format in which to display the information;
   a selection of a bet type;
   a rule for each group that determines the range of the number of positions in a bet unit that participants from its group are permitted to be in;
   a selection of a command that would evaluate a category of games of chance and enable selection of a bet type, commands, group structure and/or groups rules;
   a selection of a command that would evaluate one or more other groups selections and/or rules in determining what participants to assign to the said group;
   a selection of a command that would evaluate one or more other groups selections and/or rules in determining the rules for the said group;
   a selection of a command that determines if a condition is met at a specified time or during any period of time prior to the betting closing whether the selection is removed from the group or transferred to another group, one or more other selections are remove from groups or transferred to another group, one or more new selections are assigned to groups, and/or the rules for any group are changed;
   a selection of a command that determines if a selection meets certain requirements whether any bet unit including the said selection is to be taken as a pooled bet and/or as a fixed odd bet and the number of times any bet units can be taken; and
an instruction to store one or more of the selected commands in a module of commands;
   storing the module of commands in the database; and
operating the module of commands module to generate a wager which substantially conforms or is in accordance with the commands stored in the module of commands.

The processor may be configured to:
display on a user interface in the requested format those selections from those groups previously identified for the events selected by the user; and
store the users betting details in a data base in the database.

### BRIEF DESCRIPTION OF THE DRAWINGS

These and other features of this invention will become apparent from the following description of one example described with reference to the accompanying drawings in which:

FIG. 1 shows a football pool bet slip, using two groups, in accordance with an example embodiment of the invention;

FIG. 2 shows a football pool bet slip, using three groups, in accordance with another example embodiment of the invention;

FIG. 3 shows a “Soccer 6” bet slip in accordance with another example embodiment of the invention;

FIG. 4 shows a “Pick 3” or “Trifecta” bet slip in accordance with another example embodiment of the invention;

FIG. 5 shows a “Triple Trio” bet slip in accordance with another example embodiment of the invention;

FIG. 6 shows a lottery bet slip in accordance with another example embodiment of the invention;

FIG. 7 shows an automated wagering template in accordance with another example embodiment of the invention;

FIG. 8 shows a schematic diagram of a computer system in accordance with another example embodiment of the invention; and

FIG. 9 shows a diagrammatic representation of a machine in the example form of a computer system in which a set of instructions for causing the machine to perform any one or more of the methodologies discussed herein, may be executed.

### DETAILED DESCRIPTION OF THE DRAWINGS

In terms of proposed functioning of the system, any bet type that requires more than one selection could result in multiple bet units being produced in a wager. To provide the gambler with more control in producing and taking the bet units various computer implemented systems are available to the gambler to facilitate him in this process.

One method to control the bet units in a wager would be for the gambler using an input/output device of a computer system to instruct that the bet units (or combinations of selections that produce the bet units) are displayed, and then to be able to select one or more of the bet units (or combinations of selections) that he does not wish to be included in the wager, which will result in the unwanted bet units being exclude from the wager when it is submitted to the bet operator.

Another method to control the bet units in a wager would be for the gambler using an input/output device of a computer system to select a command that would evaluate the bet units produced by his selection and eliminate those bet units not meeting certain criteria.

Another method of eliminating (or only constructing) certain combinations of selections in a bet unit would be to allow the gambler to allocated selections to different groups and then set rules as to the number of selections from each group that may be used in constructing bet units. For example in constructing bet units that require 5 selections, the gambler could assign 3 selections to group A and 5 selections to group B, then rules set that instruct that every possible combination of 2 selections from group A must each be combined with every possible combination of 3 selections from group B in producing the bet units.

Games of chance that do not require the selections to be in a specified order in a bet unit, use groups and rules in a slightly different way as to bets types that require selections to be in a specified position in a bet unit.

Bet types that do not require the selections to be in a specified order in a bet unit include: Lotteries, certain types of football pool games, and racing bets such as a Quinella or Trio. For this bet type a specified number of selections have to be made, that may be arranged in any order in the bet unit, (it is not necessary for a selection to be assigned to occupy a specific position (space/place) in the bet unit).

An example of a football pool in this category of bet type (where selections are not required to be in a specified order in the bet unit) is the original football pool now called the “Classic Pool” (offered by Sportech PLC), where the gambler had to select eight football matches from forty nine matches that will end in a double score draw, this will be used to demonstrate one use of groups and rules. In making his selections the gambler could create a group with 2 matches he could use as bankers in every bet unit, and another group of 13 matches of which any combination of 6 matches would have to fill the remaining six positions in a bet unit. Alternatively, the said 13 matches could be divided into a group with 8 matches and another group with 5 matches, where the group with 8 matches must provide at least 3 matches and at the most 6 matches to a bet unit, and the balance of 0, 1, 2, or 3 matches to produce a complete bet unit must come from the group with five matches. The groups could be laid out in any arrangement that would allow the gambler to assign the selections to different groups and to set rules for each group; the rules being a range are set by indicating the minimum number of selections from the group that must be included in ever bet unit and the maximum number of selections from the group that are permitted to be included in any bet unit.

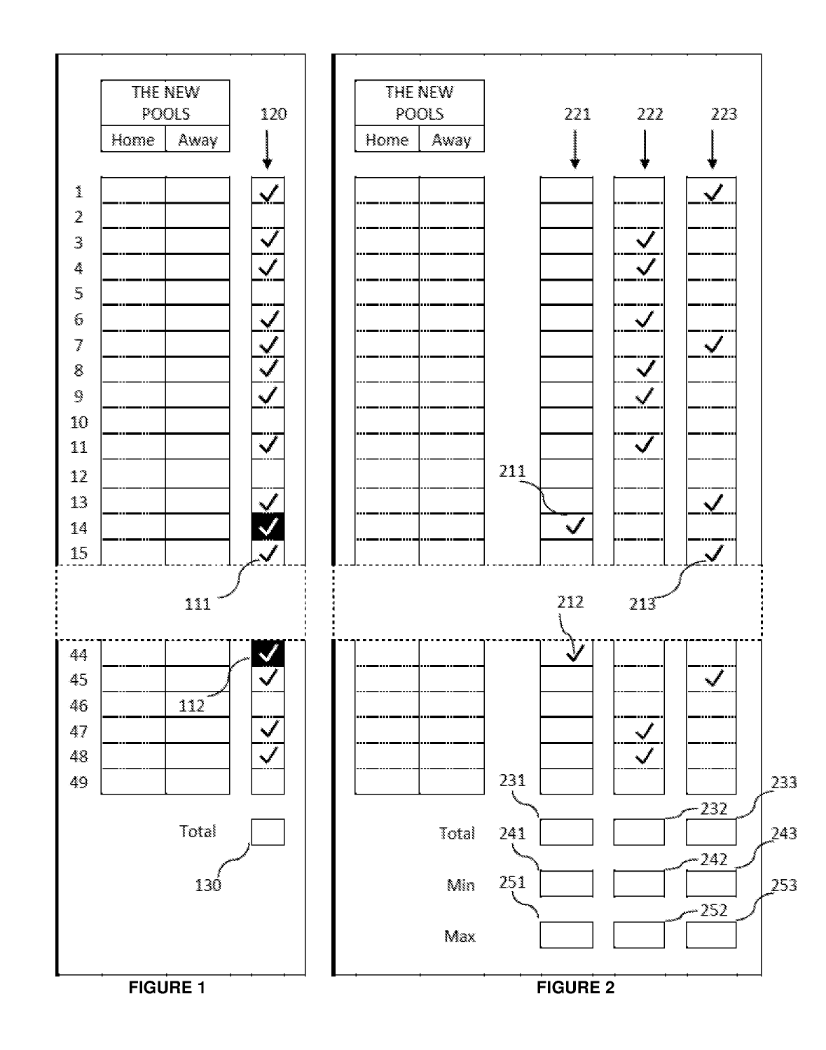

In FIG. 1, a bet slip for facilitating the offering and placement of bets to gamblers, in accordance with embodiments of the invention, is generally indicated by reference to numeral 100. The bet slip 100 refers to a bet type such as the original football pool, today known as the “Classic Pool”, and provides the use of two groups for selection purposes.

The bet slip 100 is presented to the gambler a system in accordance with an example embodiment, typically by any electronic means such as a computer terminal, laptop, note pad, smart phone or similar device. For example the system may comprise a user interface module to this end as will be described below. The bet slip 100 is split into two parts; the top part shows the first fifteen matches, and the bottom part shows the last six matches, in total there are forty-nine matches (matches sixteen to forty-three are not illustrated). The gambler is required to select at least eight matches that will end in a double score draw. The bet operator has created the possibility on the bet slip for the gambler to make use of two groups in column 120. The selection 111 is done by clicking the input field in column 120 in line with the selected match. The selection 112 is done by clicking twice the input field in column 120 in line with the selected match; the first click produces a black tick mark (as for selection 111) and on the second click the tick mark becomes white with a black background, (a third click would clear the selection). The 112 selections will be assigned to a group where the selected matches must be included in all the bet units. The selection 111 will be assigned to a different group where all possible combinations of the selected matches will be required to fill the remaining positions in a bet unit not occupied by the 112 selections. On the bet slip in FIG. 1 in column 120, there is one other selection like selection 112, both of these selections must be included in every bet unit; there are twelve other selections like the 111 selection in column 120 of which all possible combinations of six of the twelve selections will be required to fill the remaining positions in a bet unit. Field 130 would show the total number of bet units produced.

In the above embodiment of the invention, it was not necessary for the gambler to set the rules as the bet operator had provided two groups and as one of the groups was created for bankers the minimum and maximum values would automatically be the number of selections made by the gambler (limited to the maximum number of selections required in a bet unit), and therefore the other group's minimum and maximum rule would be the number of selections required in a bet unit less the number of selections made for the group of bankers. In this case the bet operator has set the rules for these two groups, more than two groups with the rules set could have been provided by the bet operator.

With reference to FIG. 2, a bet slip for facilitating the offering and placement of bets to gamblers, in accordance with embodiments of the invention, is generally described with reference to numeral 200. The bet slip 200 refers to a bet type such as the original football pool, today known as the “Classic Pool”, and provides three groups for selection purposes.

The bet slip 200 makes use of three groups. The bet operator has created three groups for the gambler to assign selected matches to, one in each of the columns 221, 222 and 223. More than three groups could have been provided, each in its own column. All selected matches assigned to a group such as selection 211 are all done by clicking the appropriate input field in the column in line with the match; a second click would clear the selection. Selections in column 221 are assigned to group one; the number two would automatically be shown in field 231 which is the total number of selections for this group. Selections in column 222 are also done by clicking the selected field once and are assigned to group two; the sum of eight would automatically be shown in field 232. Selections in column 223 are assigned to group three; the sum of five would automatically be shown in field 233. References 241, 242, and 243 are input fields used by the gambler to indicate the minimum number of selections from the above group that must be used in every bet unit. References 251, 252 and 253 are input fields used by the gambler to indicate the maximum number of selections from a group that may be made used in any bet unit. FIG. 2 as a bet slip is presented to the gambler by any electronic means such as a computer terminal, laptop, notepad, smart phone or similar device; it would also be possible to have a mark sense card printed in a similar format that the gambler could mark, which could then be read by a computer terminal.

As the principles in lottery games is the same as for the “Classic Pool” football pool game just described, the format in which the “Classic Pool” is presented in FIGS. 1 and 2 could be used to offer lottery games to gamblers. In FIG. 1 the bet slip 100 for a lottery game would enable a gambler to use two groups for selecting lottery numbers, the one group of selected numbers would be included in every bet unit and would be like the 112 selection in FIG. 1 and the other group of selected numbers would provide combinations of its selected numbers to fill the remaining positions in the bet unit not occupied by the 112 selections. A lottery game in a similar format to the football pool game presented in FIG. 2 would enable a gambler to assign lottery number to the different groups and then set rules for each group as to the number of lottery numbers from a group that may be used in constructing bet units. The gambler may wish to create groups for different purposes, such as for his lucky numbers, his car registration, numbers not drawn in the last 5 draws, even and/or odd numbers. It would also be possible for the bet operator to provide multiple groups for the gambler to utilize, some groups with lottery numbers already allocated to them such as a group of lottery numbers not drawn in the last 5 draws or a group with all the even number balls (the gambler would then merely have to set the rules for the groups), other groups with no lottery numbers allocated to it could be used by the gambler to enter his selected lottery numbers (such as lucky numbers or car registration) and then set the rules for the groups. This system where the bet operator supplies the groups with selections already allocated to it will be covered further on in the description as it can apply to many different bet types.

It would also be possible for the gambler if his selection has produced more bet units than he would wish to place with the bet operator, to indicate the number of bet units he wished to take and to use a computer generated random selection of bet units from the bet units produced by his selections. It would also be possible for the gambler to use a computer generated random selection to provide selections for any group, after indicating the number of lottery numbers that must be selected for a group.

Games of chance where the selection is required to be in a specified position in a bet unit, include bet types such as an Exacta or Trifecta for single events, and for multiple events, bet types such as a Pick 3, Quaddie, Pick 6 or in football pool games where the gambler has to predict for several matches whether the match result will be a home win, a draw or an away win.

For bet types that occur over multiple events such as a Double, Pick 3, 4, 5, 6, a Placepot (UK), a Place Accumulator or a Bi-Pot (South Africa) or football pools, the way selections are combined at present to produce wagers, is that every selection is combined with every other selection which produces every possible bet unit. By allowing multiple groups in each leg and then providing commands as to how the selections in a group from the different legs combine, gives the gambler a lot of control in producing bet units, especially in the large exotic bet types such as a Pick Six where the gambler has to predict the winner of six races. For Example, if a gambler has identified five favorites in a Pick Six that he wants to include in his wager, however he does not want to take any bet unit that has four or five favorites in it, nor does he want any bet unit that has one or no favorites in it, on present day systems he would have to complete 20 bet slips to take this wager, each bet slip using a different combination of two or three favorites from the five selected favorites. In the invention to solve this problem he would assign all five favorites to one group and then set a minimum of two and a maximum of three, thereby indicating that only bet units with combinations of two or three of the selected favorites are to be produced.

In demonstrating the use of groups in football pool bet types for multiple events, a Soccer 6 bet type is used. For a Soccer 6 the gambler has to identify for each of the six matches whether the result will be either, a home win, a draw or an away win; this bet type is shown in table A. In table A two groups are provided below each outcome, providing a total of six groups, named group A to group F, less or more groups could have been provided for use in any outcome. The chosen outcome for a match is assigned to a group by entering the group letter in line with the match in the selected outcome column. The minimum and maximum values have been set by the gambler for both groups in the lower part of table A and the totals are automatically calculated and displayed. The value in column “x” controls the way the bet units are to be taken.

TABLE A
Soccer 6

| | Home | | | | Away | | Odds | | |
|---|---|---|---|---|---|---|---|---|---|
| Outcome: | Win | | Draw | | Win | | Home | Draw | Away |
| Match | | x | | x | | x | Win | | Win |
| 1 | A | | C | | E | | 8/5 | 12/5 | 5/4 |
| 2 | A | | C | | | | 4/6 | 2/5 | 1/3 |
| 3 | B | | C | | E | | 7/5 | 11/5 | 2/1 |
| 4 | | | C | | F | | 4/9 | 7/2 | 11/2 |
| 5 | B | | C | 3P2F | F | | 4/5 | 5/2 | 7/2 |
| 6 | B | 2P | | | | | 1/5 | 6/1 | 10/1 |
| Group | A | | C | | E | | | | |
| Total | 2 | | 5 | | 2 | | | | |
| Min | 0 | | 1 | | 0 | | | | |
| Max | 2 | | 4 | | 1 | | | | |
| Group B | B | | D | | F | | | | |
| Total | 3 | | 0 | | 2 | | | | |
| Min | 1 | | 0 | | 0 | | | | |
| Max | 2 | | 0 | | 2 | | | | |

The effects of the minimum and maximum rules in table A in producing the bet units is: group A with a minimum of zero and a maximum of two must provide 0, 1, or 2 of the selected outcomes to every bet unit and group B with a minimum of one and a maximum of two must provide 1 or 2 of the selected outcomes to every bet unit; for group C with a minimum of one and a maximum of four must provide at least 1 selected match and there may be up to four selected matches in a bet unit; there need be no away win outcomes in any bet unit as both group E and F minimums are zero and up to 3 for the selected away win outcomes (1 from group E and 2 from group F as shown by their maximums) can be included in a bet unit. To aid in explaining table A, all of the groups were only used for selections from one of the three outcomes, in practice it would be possible for different outcomes to be assigned to the same group if the system was programmed to do so, for example it would be possible to assign match 2 as an away win to group C in the table A. It is also possible to assign a single outcome to 2 groups, for example it would be possible to assign the win outcome for match 1 to both group A and C, from all the bet units produced by the gamblers selection only those bet units that comply with all the groups rules will included in the wager placed with the bet operator.

Another method for a gambler to control the production of bet units is demonstrated in column “x” in table A; this allows the gambler to indicate the number of times any bet unit including that selection is to be taken (it may also be taken as a fraction of the cost), and if it is to be taken as a pari-mutuel bet and/or as a fixed odds bet. For match number 5, next to the draw selection in the “x” column, the “3P2F” indicates that any bet unit with this selected outcome is to be taken three times as a pari-mutuel bet and twice as a fixed odds bet. On the right hand side of table A the odds are automatically displayed for the different outcomes of the matches. If the gambler has indicated that some combinations are to be taken as a fixed odds wager, then the odds should be saved to the computer's memory when he places the wager with the bet operator, for the gamblers referral and to be later used as the basis for determining any possible payouts. The computer system could be programmed with a default that all bet units produced are to be taken once as a pooled wager unless the gambler has instructed otherwise.

The maximum number of bet units capable of being produced in a “Soccer 6” is 729. The selections in table A would have produced 108 bet units without the groups and rules applied, the minimum and maximum rules would have eliminated 29 bet units leaving 79 bet units to be taken.

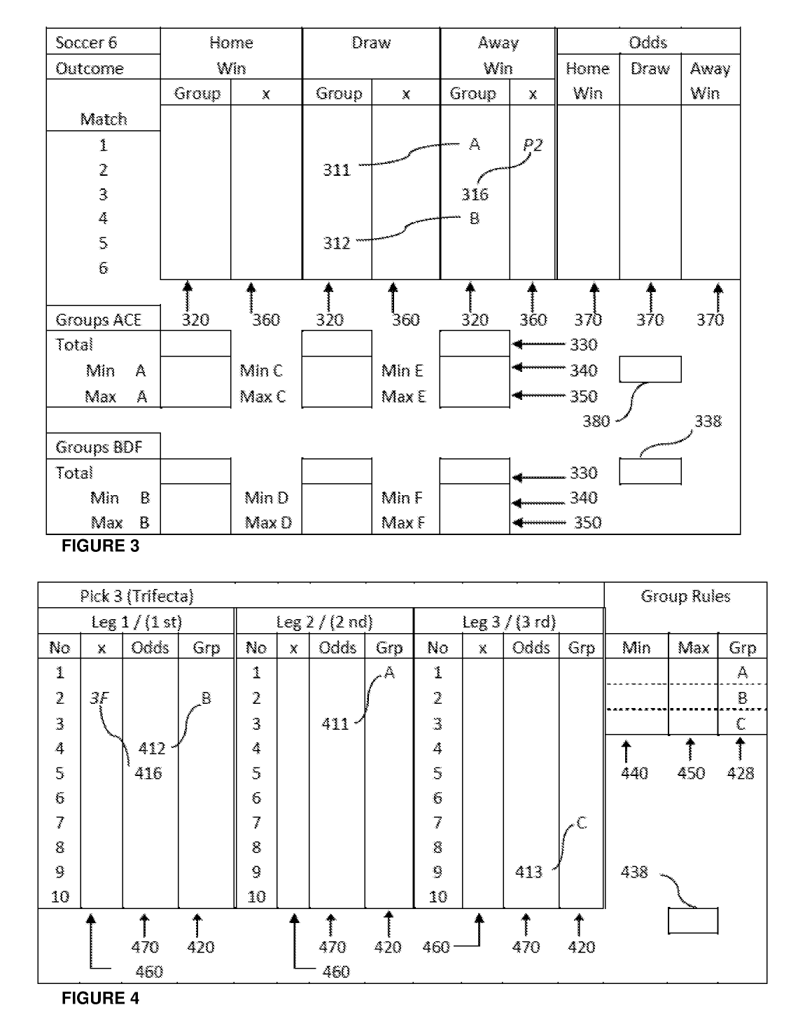

With reference to FIG. 3, a bet slip for facilitating the offering and placement of bets to gamblers, in accordance with embodiments of the invention, is generally described with reference to numeral 300.

The bet slip 300 is applied to a bet type known as a “Soccer 6” that will be used to describe and illustrate one implementation of the invention. The bet slip 300 is presented to the gambler by any electronic means such as a computer terminal, laptop, note pad, smart phone or similar device. The gambler has to select one, two or three of the outcomes for every one of the matches and assign it to any one of the groups A to F. The selected outcome for the match is done in columns 320. Reference 311 indicates a selection for match one to be an ‘Away Win’ and in making the selection the gambler has assigned the selection to group A, (by typing an “A” in the “Group” column 320, or by selecting an “A” from an option in a drop down menu). Reference 312 is a selection for match four to be an ‘Away Win’ and has been assigned to group B. Rows 330 will automatically show the total number of selections for each group. Rows 340 is where the gambler enters the minimum number of the groups selections that must be included in every bet unit. Row 350 is where the gambler enters the maximum number of selections from the group that may be included any bet unit. The minimum and maximum rules determine a range of the number of selections from the group that must be used in any one of the bet units.

Columns 360 are provided for the gambler to indicate next to any selection whether he wants to take any bet units including that selection as a fixed odds wager and/or enter it into the pari-mutuel pool, and how many times he would like those bet units to be taken. Reference 316 indicates by the “P2” entered by the gambler, that any bet unit with the selection 311 of match one being an away win, is to be taken twice and entered into the pari-mutuel pool. Columns 370 would show the odds for each possible outcome. Reference 380 is an optional selection button for the gambler, so he also has the option to take all the bet units produced as a fixed odds wager and indicate the number of times it is to be taken. Reference 338 displays the total number of bet units produced by the selection.

In demonstrating racing bet types for multiple events, a Pick 3 will be used; the object of a Pick 3 is to identify the winner of three races. Table B shows the selections that have been made for a Pick 3; the selected horses are shown by their number in the “No.” columns. Selected horses have been assigned to a group as indicated by the letter in the “Grp” columns and the minimum and maximum rules for each group has been set as shown by the number in the “Min” and “Max” columns. When the gambler assigns horses to groups he will mostly be doing this based on some factor such as the odds, a tipster's recommendations, speed ratings, or jockeys. To allow the gamblers to sort and display the possible selections based on these factors, would greatly assist them in assigning their selections to the groups. In table B the number in the “No.” column represents the position the horse is ranked in the field of participants based on its odds, the horse shown as number “1” has the highest odds and is referred to as the favorite.

TABLE B
Pick 3

| | | | |
|---|---|---|---|
| Leg 1 | Leg 2 | Leg 3 | Group Rules |

| No. | Odds | Grp. | No. | Odds | Grp. | No. | Odds | Grp. | Min | Max | Group |
|---|---|---|---|---|---|---|---|---|---|---|---|
| 1 | 11-10 | A | 1 | 18-10 | A | 1 | 4-1 | A | 1 | 1 | A |
| 2 | 9-2 | B | 2 | 3-1 | B | 2 | 9-2 | B | 1 | 2 | B |
| 3 | 9-1 | B | 3 | 4-1 | B | 3 | 5-1 | B | | | |
| | | | 4 | 8-1 | B | | | | | | |
| | | | 5 | 11-1 | B | | | | | | |
| | | | 6 | 14-1 | B | | | | | | |
| | | | | | | 6 | 8-1 | C | 0 | 1 | C |
| | | | | | | 7 | 10-1 | C | | | |
| | | | | | | 8 | 12-1 | C | | | |
| | | | | | | 9 | 12-1 | C | | | |

Referring to table B, in explanation of some of the effects of the groups and rules, all the favorites have been allocated to group A with the minimum and maximum both set as one, this indicates that all bet units must have one favorite in it, and that all three favorites will each be used separately in different bet units; if the minimum had been set at zero it would then allow other bet units to be produced that do not have a favorite in it; if the minimum and maximum was set as two then all bet units would have to have two favorites in them, and if the minimum and the maximum was set as three then the only bet unit of all three favorites would be produced. If a gambler wanted to bank one favorite and use it with each of the other two favorites separately in producing the bet units, then the one favorite would be allocated to its own group and the minimum and maximum set as one, then the other two favorites would be allocated to a different group and the maximum set at one so that both would alternatively be used with the banked favorite in producing the bet units, (the minimum could then be set at either zero or one). The rules for group B in table B indicate by the minimum of one that at least one of the legs in ever bet unit must have a selection from group B, and by the maximum of 2 that at the most two of the legs in any bet unit may have group B selections. The minimum rule of zero for group C indicates that its assigned selections do not have to be included in any bet unit, and the maximum of one indicates that its selections may be used in any bet unit.

If the groups rules were not applied then the selections in table B would have generated 126 bet units (3×6×7); with the groups rules being applied this would produce 52 bet units as shown in table C below. In table C in column A, the group's letters are displayed in all possible combinations as per the gambler's selections in tablet B. In Table C, Column B shows the number of horses selected in each leg for the group per the combination in column A. Column C is the total number of bet units produced which is the product of column B. Column D shows if any, which rule (s) eliminated the combination (or prevented it from being produced) in column A. Column E shows the remaining number of bet units after elimination.

TABLE C

| A | B | C | D | E |
|---|---|---|---|---|
| A × A × A | 1 × 1 × 1 | 1 | A max B min | |
| A × A × B | 1 × 1 × 2 | 2 | A max | |
| A × A × C | 1 × 1 × 4 | 4 | A max B min | |
| A × B × A | 1 × 5 × 1 | 5 | A max | |
| A × B × B | 1 × 5 × 2 | 10 | | 10 |
| A × B × C | 1 × 5 × 4 | 20 | | 20 |
| B × A × A | 2 × 1 × 1 | 2 | A max | |
| B × A × B | 2 × 1 × 2 | 4 | | 4 |
| B × A × C | 2 × 1 × 4 | 8 | | 8 |
| B × B × A | 2 × 5 × 1 | 10 | | 10 |
| B × B × B | 2 × 5 × 2 | 20 | A min B max | |
| B × B × C | 2 × 5 × 4 | 40 | A min | |
| | Totals | 126 | | 52 |

Table B could have included a column to control the number of times a bet unit is taken and whether it is to be taken as a pooled wager and/or as a fixed odds wager, as was demonstrated in the “x” columns in table A.

For bet types that are designed around a single event or leg such as an Exacta, Trifecta or Superfecta (Quartet) that require predicting the correct finishing order of participants in a race, groups and rules work in the same manner as for bet types that occur over multiple events, therefore the bet types for single events are presented in the same format as in table B, (but the selection is for a finishing position and not a leg).

With reference to FIG. 4, a bet slip for facilitating the offering and placement of bets to gamblers, in accordance with embodiments of the invention, is generally described with reference to numeral 400.

The bet slip 400 applies to bet types known as a Pick 3 or Trifecta. The illustrated bet slip is presented to the gambler either by any electronic means such as a computer terminal, laptop, notepad, smart phone or similar device, or it could be adapted into a mark sense card (the columns for the odds would not be shown on a mark sense card).

The columns 420 are provide for the gambler to assign the selected horse to a group (s). In selecting the horses in the different legs or for finishing positions, the gambler makes the selection by entering the group letter in any of column's 420, as shown by reference 411 he has assigned the first listed horse in leg 2 to group A; for reference 412 he has assigned the second listed horse in leg 1 to group B and for reference 413 he has assigned the seventh listed horse in leg 3 to group C. The gambler could either enter the letter directly into the column, or the different groups letter could be displayed next to each horse and he could select one of the letters (two, or three letters if the computer system was programmed to accept the same selection in more than one group) to indicate which group (s) he wanted to allocate the horse to, or he could select the group from a drop down menu. Columns 460 are utilized by the gambler to indicate whether any combination containing that selection is taken as a pooled wager and/or as a fixed odds wager, and the number of times any bet unit is to be taken; reference 416 indicates that any bet unit with number two in leg one (or in first position) is to be taken three times as a fixed odds bet. Columns 470 show the odds for each horse in the different legs (positions).

Column 428 displays the group's letter for the three groups provided by the bet operator, references 411, 412, and 413 each indicate that a horse was assigned to group A, B, and C respectively. Column 440 is where the gambler indicates for each of the groups shown in column 428, the minimum number of legs (finishing positions) containing that group's selections that must be used in ever bet unit; column 450 is where the gambler indicates for each of the groups shown in column 428, the maximum number of legs (finishing positions) containing that group's selections that may be used in a bet unit. Reference 480 is an optional selection button for the gambler, so he has the option to take the bet with fixed odds otherwise the bet will be combined with the other bets in a pool. Reference 438 displays the total number of bet units produced.

Some bet types have selections in no specific order, and in a specific order. A bet known as a Triple Trio (offered by the Hong Kong Jockey Club and the New Zealand TAB), is made up of three races where the gambler must select three horses in each race (referred to as a trio or a primary combination) to fill the first, second and third finishing positions in any order, the primary combinations have to be in a specified order (position) in the bet unit. A way of offering the bet to gamblers to give them more flexibility in making their selections, would be to allow the gambler to use groups and rules to produce trios of horses in each leg, and then to control how these trios are combined in producing the bet units a different set of groups and rules could be used. Other alternatives to control what bet units are produced, firstly would be to allow the gambler to select commands to evaluate all bet units and eliminate those not meeting specified criteria; and secondly to permit the gambler to view the bet units as produced by his selections (and/or combinations of trios that will produce the bet units), and then to be able to select those bet units and or combinations of primary combinations that produce the bet units he wishes to eliminate when the bet is placed with the bet operator.

TABLE D
Triple Trio

| | | Leg 1 | | Leg 2 | | Leg 3 | | | | |
|---|---|---|---|---|---|---|---|---|---|---|
| Group | | No. | Grp. | No. | Grp. | No. | Grp. | Group | Min | Max |
| 1 | | 1 | A, B | 1 | A, B | 1 | A, B | A | 1 | 3 |
| 1 | | 2 | B | 2 | B | | | | | |
| 1 | | 3 | B | 3 | | | | B | 0 | 2 |
| 1 | | | | 4 | | | | | | |
| 2 | | 4 | | | | 2 | B | | | |
| 2 | | 5 | | | | 3 | | | | |
| 2 | | 6 | | | | | | | | |
| 3 | | | | | | 4 | | | | |
| 3 | | 7 | C | | | 5 | C | C | 0 | 1 |
| 3 | | 8 | C | | | 6 | C | | | |
| 3 | | | | | | | | | | |
| Group | | | | | | | | | | |
| 1 | Min | 1 | | 3 | | 0 | | | | |
| | max | 3 | | 3 | | 1 | | | | |
| 2 | Min | 0 | | 0 | | 0 | | | | |
| | max | 2 | | 0 | | 2 | | | | |
| 3 | Min | 0 | | 0 | | 0 | | | | |
| | max | 1 | | 0 | | 1 | | | | |

Referring to table D; for the gambler to control the mix of the selected participants in the trios, the numeric groups (1, 2 & 3) and the rules in the bottom part of table D are used to control the number of trios that include certain of the selected participants to be used in producing the bet units, the gambler makes use of the alphabetic groups (A, B and C) and their rules located on the upper right part of table D. In table D the selected horses have been shown by their number (ranking) in the “No.” column in line with the numeric group they have been assigned to, the numeric group is shown in the first column (1, 2 & 3). If a horse is assigned to an alphabetic group then the letter for the group is shown to the right of the assigned horse. The rules have been set by the gambler for both the numeric and alphabetic groups, as shown by the values in the input fields or the minimums and maximums.

TABLE E

| Leg 1 | | | Leg 2 | Leg 3 |
|---|---|---|---|---|
| 123 | | | 123 | 123 |
| 124 | | | 124 | 124 |
| 125 | | | | 125 |
| 126 | | | | 126 |
| 127 | | | | |
| 128 | | | | |
| 134 | 234 | | 134 | 134 |
| 135 | 235 | | | 135 |
| 136 | 236 | | 234 | 136 |
| 137 | 237 | | | |
| 138 | 238 | | | 234 |
| 145 | 245 | 345 | | 235 |
| 146 | 246 | 346 | | 236 |
| 147 | 247 | 347 | | |
| 148 | 248 | 348 | | |
| 156 | 256 | 356 | | |
| 157 | 257 | 357 | | |
| 158 | 258 | 358 | | |
| 167 | 267 | 367 | | |
| 168 | 268 | 368 | | |

Table E shows the trios produced in each leg by the numeric groups in table D. As shown in the three legs in table E, the first leg has 43 trios, the second leg has 4 trios and the third leg has 10 trios. The numeric groups may also produce combinations of more and less than three horses but these are disregarded as only trios are required. A gambler may want to use all the trios in table E to produce bet units, but may not want to wager on every possible combination of these trios. For example he may not want to use trios that result in a bet unit that has many favorites in it (e.g. [123]×[123]×[123]), or a bet unit that has no favorite in any leg (e.g. [368]×[234]×[236]). Referring to table D, to control the way trios are combined into bet units the gambler has allocated the three favorites (number 1) to group A, seven horses to group B, and four horses to group C.

Referring to table D, the rule for group A stipulates that there must be at least one favorite (number 1) in one of the trios in a bet unit as indicated by the minimum of one, and all three trios in a bet unit may include the favorite as indicated by the maximum of three. In a Triple Trio as the bet units are made, up of three horses in each leg, when multiple horses in a leg are allocated to the same group (a group that controls the way trios are combined in the bet unit, such as the alphabetic groups in table D), we now have an option to indicate whether the selected horses are to be considered individually or as unit with another selected horse from the same event in a trio (primary combination) when being evaluated by the minimum and maximum rules. For example in table D, in the first leg numbers 1 and 2 have been allocated to group B, if 1 and 2 are considered individually then the trio of (1×3×4) would be counted (as it has the number 1 in it) when determining whether the minimum and maximum rules would allow that number of trios with its groups selections in a bet unit;, if it had been indicated 1 and 2 must be considered as a unit then the trio (1×3×4) would not be counted (as it does not have the selections 1 and 2 in the trio).

Referring to table D for group B, for this example in the first leg the combinations of horses (1×2) and (1×3) are to be considered as a unit but the combination of horses (2×3) is not considered as a unit (the gambler would stipulate this when he assigns the selections to the alphabetic groups). In both legs two and three for group B, the combination of horses (1×2) is to be considered as a unit. The rule for group B therefore stipulates that the unit of horses numbered 1 and 2 in every trio of a bet unit is not allowed, nor is the unit of 1 and 3 in the first trio with the unit of 1 and 2 in both the other trios allowed, (two or less trios in a bet unit may contain these units as the maximum is two and the minimum is zero); this would result in bet units having many favorites in them being eliminated. For group C in this example it was stipulated that all the assigned horses are to be considered individually in their trio when being evaluated by the rules, so the rule for group C indicates that no bet unit is to include any of its assigned horses in leg one with any of its assigned horses in leg three, this would eliminate bet units that have trios with the lesser ranked selections (outsiders) in both of these legs. It is possible for a gambler to stipulate for the selections in a leg that some selected horses would be considered as a unit and other horses individually when being evaluated by the group's rules. In a computer system, selections for these groups could by default be considered individually, with an option for the gambler using an input/output device to override the default by indicating for any selection when assigning it to a group (a group that controls the number of primary combinations with selections from a group permitted in a bet unit) that it is to be considered as a unit and then to select one or more other selections from the same event that it is to be considered as a unit with. Another method to control whether selections are considered individually or as a unit would be to allow the gambler to select a command that instructs that all selections in a leg from a group (or in selected events from the group), are to be considered as units of a specified number of selections in any primary combination, for example, a selected command could stipulate that all selections are to be considered as a unit with every other selection in the leg. The selected command could further include criteria that units of selections are to be formed only if certain criteria are met, for example a selected command could instruct that the highest ranked horse must form a unit with each other horse in the trio in those events when the favorites odds are less than 2/1.

To produce a wager in a bet type like a Triple Trio, the gambler does not have to assign any of the selected participants to groups that control the number of primary combinations (including its selections) that can be used to produce bet units (the alphabetic groups in the above example). The use of these groups limits the number of primary combinations (containing certain selections) that may be used in a bet unit, therefore by not using these groups all possible combinations of primary combinations will be used in producing the bet units.

Without any of the minimum and maximum rules applied, the selection in table D would have produced 56 trios in leg one, 4 trios in leg two and 20 trios in leg three, thereby producing a total of 4480 bet units (66 ×4×20); by applying the numeric groups' minimum and maximum rules to the selections it produced 43, 4 and 10 trios in legs 1, 2 and 3 respectively (refer table E), this would result in 1720 bet units being produced (43×4×10). By applying the alphabetic groups rules to these 1720 bet units, rule A would eliminate 69 bet units, rule B would eliminate 88 bet units, and rule C would eliminate 432 bet units, however 32 bet units are eliminated by both the minimum of rule A and the maximum of rule C, and 4 bet units by the maximum of rules B and C, therefore the net number of bet units eliminated would be 553, thereby producing 1167 bet units in the wager.

In table E for each of the 43 trios in leg 1, there are 40 bet units that originate from it, these being the combinations produced by each of the 4 trios from leg two combined with each of the 10 trios from leg three, in total 1720 bet units. Table F is a sample of the bet units produced.

TABLE F

| Trios | Rule | Trios | Rule | Trios | Rule |
|---|---|---|---|---|---|
| 127 - 123 - 123 | B | 147 - 123 - 123 | | 368 - 123 - 123 | |
| 127 - 123 - 134 | | 147 - 123 - 134 | | 368 - 123 - 134 | |
| 127 - 124 - 123 | B | 147 - 124 - 123 | | 368 - 124 - 123 | |
| 127 - 124 - 125 | B C | 147 - 124 - 125 | C | 368 - 124 - 125 | C |
| 127 - 124 - 134 | | 147 - 124 - 134 | | 368 - 124 - 134 | |
| 127 - 124 - 135 | C | 147 - 124 - 135 | C | 368 - 124 - 135 | C |
| 127 - 124 - 136 | C | 147 - 124 - 136 | C | 368 - 124 - 136 | C |
| 127 - 124 - 235 | C | 147 - 124 - 235 | C | 368 - 124 - 235 | C |
| 127 - 234 - 136 | C | 147 - 234 - 136 | C | 368 - 234 - 136 | C |
| 127 - 234 - 234 | | 147 - 234 - 234 | | 368 - 234 - 234 | a |
| 127 - 234 - 235 | C | 147 - 234 - 235 | C | 368 - 234 - 235 | a C |
| 127 - 234 - 236 | C | 147 - 234 - 236 | C | 368 - 234 - 236 | a C |

Table F is divided into three parts, the left part lists twelve of the forty bet units that originate from the trio (127) in column one of table E, the middle part lists twelve of the bet units that originate from the trio (147) in column one in table E, and the right part lists twelve of the bet units that originate from the trio (368) in column three in table E. In each row in table F the last two trios in each of the three bet units are identical. In table F the rule (s) that eliminated the bet unit are shown in the column headed “Rule” of each part of table F, if the letter is a capital letter then the bet unit was eliminated by a maximum rule, and if it is a small letter then it was eliminated by a minimum rule, those bet units without a letter next to it would be the some of the bet units to be placed with the bet operator (ditto marks have been used to make the tables easier to read).

Another method to control the way trios are combined into bet units, would be to allow the gambler to assign trios to one or more groups and set rules as to the number of trios from the group permitted in a bet unit. For example referring to table E, the gambler could assign the last six trios in the last column of leg one and the last three trios in leg three to a group, then set a minimum rule of zero to indicate that none of the assigned trios have to be included in a bet unit, and a maximum rule of one to indicate that at the most only one trio from the group may be included in a bet unit at a time. Assigning trios to groups and setting the rules follows the same principles as when assigning horses to groups and setting the rules.

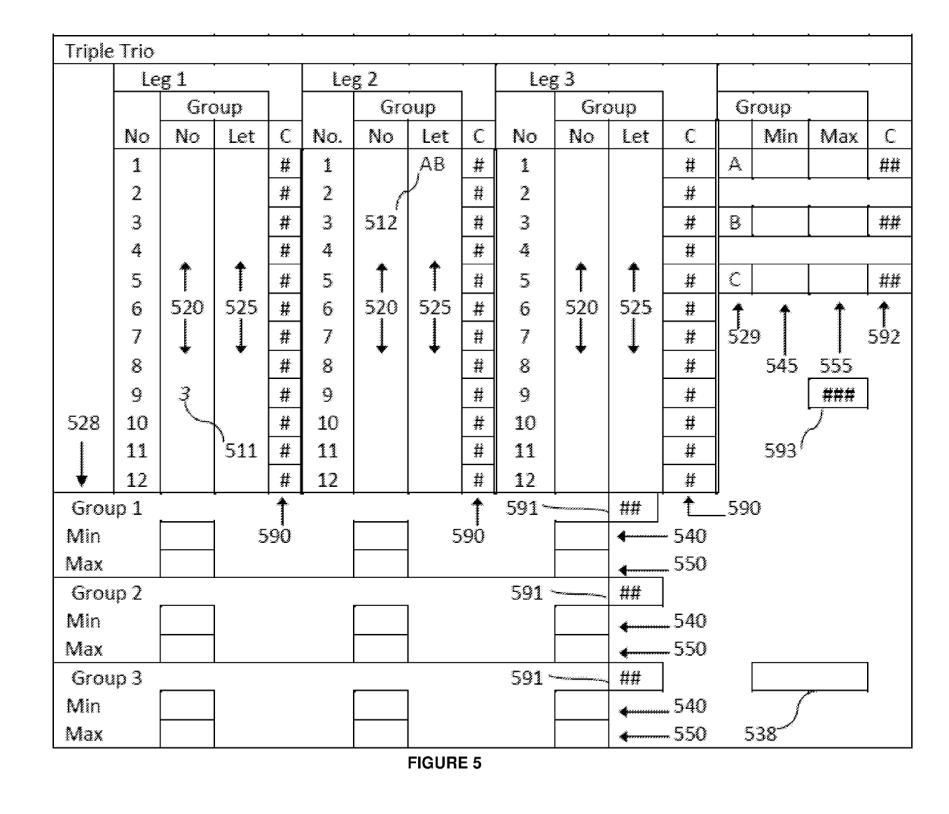

With reference to FIG. 5, a bet slip for facilitating the offering and placement of bets to gamblers, in accordance with embodiments of the invention, is generally described with reference to numeral 500. The bet slip 500 is used in making a selection for a bet type such as a Triple Trio. The bet operator has provide for the use of twelve groups (3 groups in each leg to control the production of trios, and 3 groups to control the trios used in the bet units), more or less groups could have been provided. The bet slip 500 is presented to the gambler by any electronic means such as a computer terminal, laptop, note pad, smart phone or similar device.

In FIG. 5 columns 520 are utilized by the gambler to assign the selections to the numeric groups; columns 525 are used to assign the selections to the alphabetic groups. Reference 511 indicates horse number nine in the first leg was assigned to numeric group three, reference 512 indicates horse number one in the second leg was assigned to group A and to group B (it would have also been assigned to a numeric group). Reference 528 shows where the numeric groups rules are displayed and reference 529 shows where the alphabetic groups rules are displayed. Rows 540 is where the gambler enters the minimum number of selections from the above numeric group that must be in each trio, and rows 550 is where the gambler enters the maximum number selections from the numeric group that may be used in any trio. Column 545 is where the gambler enters the minimum number of trios having selections from its group that must be used in producing the bet units, and column 555 is where the gambler enters the maximum number of trios having selections from its group that may be used in producing the bet units. Columns 590 are where the gambler selects to add commands to a horse; references 591 indicates where commands are added for the numeric groups; column 592 is where commands are added for the lettered groups; reference 593 indicates where commands are added that apply to all bet units being evaluated. Reference 538 indicates the total number of bet units produced.

For all bet types, yet another method to control what bet units are to be produced would be allow the gambler using an input/output device to view the bet units and/or combinations of selections (or combinations of trios) that produced the bet units, and to be able to select one or more bet units and/or one or more combinations of selections (or combinations of trios) for elimination when the bet is submitted to the bet operator.

For all bet types, another method to control the production of bet units would be to allow the gambler to select commands that would evaluate each bet unit produced by the gamblers selection, and handle the bet units as required by the command. For example, should the gambler decide that he does not want to take any bet unit that has horse number 3 in the 3rd leg and horse number 5 in the 5th leg, he could using an input/output device select one of multiple commands (from a menu with commands) that instructs “ if horse number [x,y,z] in leg [x] is included in the same bet unit as horse number [x,y,z] in leg [y] then the bet unit must be [eliminated, not eliminated, taken as a pooled bet [x] times, taken as a fixed odds bet [x] times]”; he would enter or select the required details in the square brackets of the said command, the command would then read, “if horse number [3] in leg [3] is included in the same bet unit as horse number [5] in leg [5] then the bet unit must be [eliminated]”. The command selected in the previous example would be applied immediately to the bet units produced by the gamblers selection to produce a wager, other commands could be selected that need to evaluate data closer to the start time of the event before being able to produce a wager. For example a command could be selected that instructs that all bet units containing selections from group C (or horse number [x] in leg [y]) must be taken twice as a fixed odds bet if the favorites odds are better than 15/10 one minute before the start time of the event. Commands developed by the bet operator and made available to the gambler could evaluate any criteria and perform many different tasks, for example remove or replace selections in groups, transfer selections between groups, include other selections in groups, change the group structure, change any groups minimum and/or maximum rules, change or select whether any bet unit is taken as a pooled bet and/or fixed odds bet and the number of times any bet unit is to be taken. A gambler could also create a group with a minimum and maximum of zero (meaning no selections from this group would be permitted to be used in any bet unit) and then selections for this group could have commands that would transfer the selection to another group (that is active) if certain criteria are meet.

For all bet types, when setting the maximum or minimum number of selections to be used in a bet unit, it is possible to enter a value that would result in not all the groups rules to be used to the full extent in producing the bet units, as the maximum for a group added to the minimums of the other groups exceeds the number of selections that are required in a bet unit; for example in a Pick 3 if one group has its minimum value set at one, then the maximum for any other group cannot be three as it is only possible to utilize two more selections to produce a bet unit. The computer system should not be programmed to prevent the gambler from entering a number greater than the number of selections possible to use, as his next intention may be to adjust another rule, but the gambler should be warned that it is not possible to produce all the bet units as required by each group's rules.

For all bet types in using groups and rules, if all the selections are assigned to one group (that covers every event, leg or position) and the minimum and maximum are set at the minimum number of selections required to produce a bet unit, this will then produce the exact same bet units as if the same selections were taken using present day tote systems. In present day tote systems, bet units produced by using keys (bankers) and wheels (roving selections), can be replicated using groups and rules by assigning the keys (bankers) to one group (that covers all the positions) and then set the minimum and maximum at the number of keys (bankers) selected (but limited to the number of selections required in a bet unit), then the selections forming the wheel (roving selections) are allocated to a different group (also covering all positions) and the minimum and maximum are set at the number of selections required to produce a bet unit less the number of keys (bankers) selected. In present day tote systems, bet units produced by using boxed bets, can be replicated using groups and rules by assigning all the selections to one group (covering all positions) and then setting the minimum and maximum at the number of selections required in a bet unit.

All present day games of chance that require multiple selections to produce a bet unit, are capable of being adapted into new games of chance by using groups and rules. This could be achieved by allowing the bet operator to assign the participants (preferably all the participants) to groups and then the gambler would merely have to set the rules for the groups to produce a wager. An example of a present day bet type that could be adapted into a new bet type is the football pool game referred to as the ‘Soccer Six’ as shown in FIG. 3 and in table C. Referring to FIG. 3, the bet operator would assign all the possible selections for a “Home Win” outcome to group A, all the possible selections for a “Draw” outcome to group C and all the possible selections for an “Away Win” to group E, and then the gambler would have to predict the number of home wins, draws and away wins by entering a minimum and a maximum value for each of the three groups A, C and E. Group B in FIG. 3 could be used for a different prediction such as where the gambler has to predict the total number of goals that will be scored in home wins, draws, and away wins. Other groups could be added for the gambler to make further predictions, such as the number of red cards that will be issued. These different groups for the different predictions could each be offered as a separate wager or combined into a single wager.

Another present day game of chance that is able to be adapted in a new game of chance by using groups and rules are lottery games, the bet operator could assign lottery numbers to groups, and then the gambler to produce a wager would have to set the minimum and maximum rules for the groups to predict a range for the number of lottery numbers that will be drawn from each group. In addition the operator could divide a set of lottery numbers into a number of different groups and assign a different color to each group, then the gambler would have to predict the number of colors that will drawn from each group. The same set of lottery balls could be divided into another set of groups and each group assigned a different symbol, and then the gambler would have to predict the number of symbols that would be drawn from each group by setting the rules. There needs to be no relationship between the numbers, the colors and the symbols. The new lottery games could be either incorporated into the traditional lottery game, offered as an additional wager or as a bonus game.

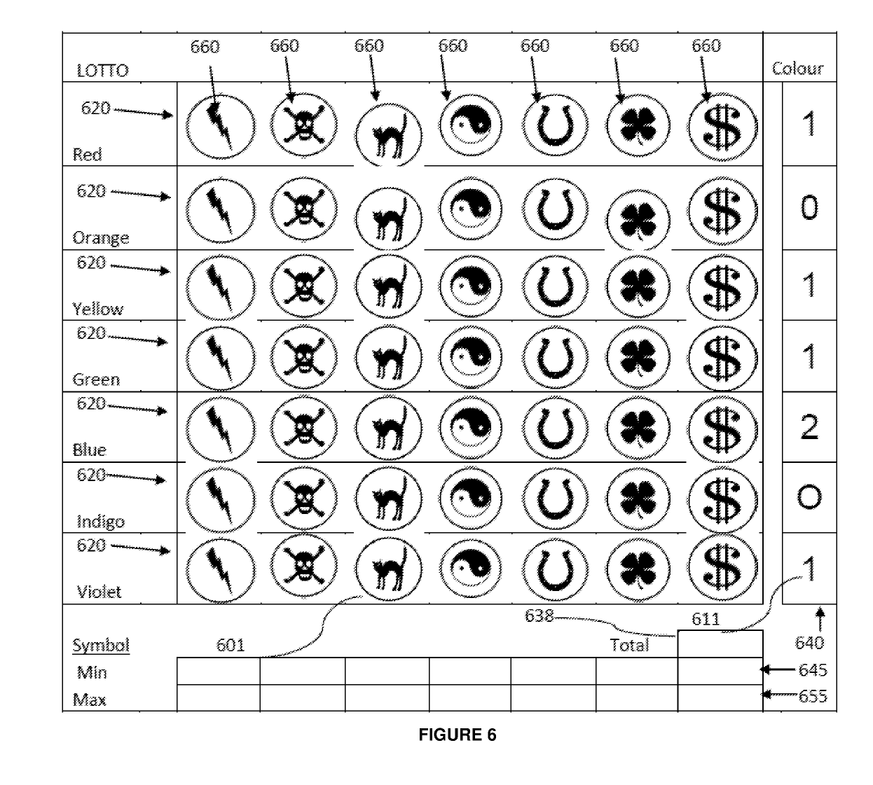

With reference to FIG. 6, a lottery bet slip for facilitating the offering and placement of bets to gamblers, in accordance with embodiments of the invention is generally described with reference to numeral 600. The bet slip 500 is presented to the gambler by any electronic means such as a computer terminal, laptop, note pad, smart phone or similar device.

Referring to FIG. 6, reference 601 shows one of the forty-nine lottery balls. The bet operator has divided the set of lottery balls into groups of seven different colors with each row 620 representing a different color, and into seven groups of different symbols with each column 660 representing a different symbol, (the numbers for the balls are not shown as they have no influence on this lottery game). To predict the color of the six balls to be drawn the gambler must indicate in column 640 the exact number of balls of that color that he expects will be drawn, reference 611 shows one such prediction where the gambler has entered that he expects one violet colored ball to be drawn. For the symbols, in selecting the range of the number of symbols he expects to be drawn in each column, the gambler has to indicate in row 645 the minimum number of symbols that he expects to be drawn from each of the above groups, and in row 655 the gambler has to indicate the maximum number of symbols that he expects to be drawn from each of the above groups. Reference 638 shows the number of bet units produced when the minimum rules 645 and the maximum rules 655 for the symbols groups are set.

The invention is especially suited for being developed into games of chance for sporting events that have a large number of participants that covers many events, as the invention allows the gambler for the same stake to be able to select more participants and then reduce the number of bet units produced by setting the rules, the increased number of selections results in many gamblers not getting eliminated as easily in the earlier events (as compared to traditional selection methods) as the eliminations generally start to happen in the latter events as the rules begin to apply, thereby providing greater excitement for the gamblers.

The invention can also be developed into new bet types, for example in a golf tournament a game of chance could be developed where the gambler would have to select a player and then for a round of golf predict for each hole whether he will play it below par, at par or above par. This would have the same format as the ‘Soccer 6’, (refer FIG. 3 and table C) but would have 18 events for which the gambler has to predict an outcome. Another example of a possible new game of chance is one that could be developed around a motor race series such as Nascar, where the winning driver (or team) has to be predicted for each race throughout the season or over a series of selected races, this would be have the same format as a Pick 6.

Automated Gambling

Most gamblers style of gambling follows a pattern, for example, one gambler could wager using a method that is very defined in the selection process, another may take a Pick 6 only if there is a pool carried over from a previous meeting and/or if the track condition is firm, another may only take win and place wagers in certain situations, another may take wagers on certain jockey and trainer combinations, and another may wager on trifecta bets if the favorite's odds are less than 15/10 and it has a stable companion entered in the same race. These different patterns of gambling could be programmed into a module of commands that would be processed by a computer processing module to aid the gambler in wagering activities. A module of commands would be able to evaluate forthcoming races to produce reports or wagers automatically, or evaluate past races and produce reports.

Groups and rules act as a powerful tool in developing a module of commands to automatically produce wagers and reports. As shown previously, groups are generally created for selections with similar characteristics (e.g. favorites, outsiders, jockey/trainer combinations or horses with a high probability of placing). The gambler could select commands for groups that would analyze all the participants in a game of chance and then assign those participants meeting certain criteria to the group, the gambler could then set rules for these groups or a command could set rules for these groups, for example a command could instruct that the minimum rule is to be set at zero and the maximum rule set at two if there are more than two events (legs) having selections otherwise it is to be set it at one. In a computer system for the gambler to select commands, this could be achieved by having many prewritten commands displayed in a menu from which the gambler using an input/output device would select any number of, he may then adjust the commands to include his own criteria.

When a gambler selects a command that evaluates and assigns participants to the group, the gambler will need to indicate which events or finishing positions in the game of chance the command is to evaluate, this could be achieved by either allowing the gambler to nominate which events (legs or postions) the command is to evaluate or by setting criteria as to which events (legs or positions) the command is to evaluate. For example a command for a group that selects outsiders in a Pick 6 could be instructed to only make selections in those races where the favorite has less than a twenty five percent chance of winning (based on the opening odds), or a command making selections for a group in a Superfecta could be programmed to select outsiders only for the fourth finishing position if its odds are less than 10/1 and if it has placed over the same distance in the past. Alternatively the command by default would evaluate all events or finishing positions in a game of chance with an option for the gambler to override the default when selecting the command.

To create a module of commands to automatically produce a wager in a Pick 3, where every bet unit produced must have a favorite in one leg, the second and third ranked horse in another leg, and the horse ranked last (the biggest outsider) in the remaining leg, then the gambler using a computers input/output device would follow a procedure such as: select the category for the game of chance (e.g. horse racing, football pools, lotteries), this would then produce a list of every bet type for that category from which the gambler would select a bet type and this would then display a template with input fields having the appropriate commands and input data for the bet type for the gambler to complete, in the template he would then select that he wants to create three groups, and for each group select that he wants to add a command which would then produce a menu containing commands; for group A he would select the command that instructs that “the favorite is to be included in every leg of group A”, for group B he would select a command containing adjustable criteria that instructs that “the horses ranked [x] to [y] are to be included in group [z] ”, then he would substitute the [x] with a 2, the [y] with a 3 and the [z] with a B; for group C he would select a command instructing that “the horse ranked last (outsider) must be selected for group C”. The gambler would then set the minimum and maximum rules for the groups, in this case a minimum and maximum of one would be set for every group. This module of commands would then be able to be saved to the computer's memory and then be recalled to analyze any three races and be capable of producing the required bet units.

The above example was a simple module of commands as the gambler knew the exact format of the wager he wanted to take. In developing another module of commands the gambler may want to evaluate the gaming data before a decision as to what bet type is to be used. For example, in a race meeting where in 6 consecutive races the gambler has the option of either taking a Pick 4 or a Pick 6, the 6 favorites odds are (5/10, 11/10, 18/10, 25/10, 3/1 and 4/1) and their respective winning probabilities are (73%, 46%, 34%, 25%, 21%, and 16%) giving a total of 215%; then a command could be selected that reads: “if the sum of all six favorite's probability of winning is greater than 180% then assign those 5 favorites with the highest probability of winning to a group and set the minimum as 2 and the maximumas 3 for a Pick 6 wager, otherwise assign those 3 horses (from the four Pick 4 races) with the highest probability of winning and set the minimum as 1 and the maximum as 2 for a Pick 4 wager”; as the total probability of the favorites winning of 215% was above the 180% threshold, this would result in 5 favorites being selected for the group and a minimum of 2 and a maximum of 3 being set for a Pick 6 wager. For each bet type refered to in the command (the command selecting the bet type), a module of commands would be developed (as discussed previously) to produce the wager for the bet type.

A command like this that evaluates a number of events to determine what bet type to use, could be instructed to select a module of commands that will be used in producing wagers for this bet type, either the gambler or another entity would have previously developed the module of commands.

Commands could be used that analyze the other groups' selections before assigning selections to its group and setting the rules. For example, a command for assigning outsiders to a group could instruct: “if no favorite has been selected for the leg then select all those horses with odds greater than 10/1 and less than 40/1, and set the minimum to 0 and the maximum to 1”; if this command was part of the module of commands in the just mentioned example, this would result in outsiders getting selected in one leg for the group (as 5 of the 6 favorites had been selected in the example) and the rules being set at zero and one, (commands could also have been selected that would have evaluated some criteria to determine what the groups rules would be set at).

In developing a module of commands for bet types (such as a Triple Trio in horse racing) where multiple selections in an event are required to produce a primary combination which is then combined with other primary combinations from other events to produce a bet unit, the procedures mentioned in the previous paragraphs are also used to produce a module of commands, the groups, rules and commands to produce the primary combinations are also created as mentioned in the previous paragraphs. For the gambler to control the construction of the bet unit he has the option of controlling either, the number of primary combinations having selections from the same group that are permitted to be used in producing a bet unit, or the number of primary combinations from a group that are permitted to be used in producing a bet unit.

For a gambler in developing a module of commands, to control the number of primary combinations having selections from the same group that are permitted to be used in producing a bet unit, he would select a command (s) that would assign any of the selected participants (those selected to be included in primary combinations) to one or more groups (not any of those groups used to produce the primary combinations) and sets the rules for the group (s), the rules for a group determine the range of the number of primary combinations having selections from its group that are permitted to be used in producing a bet unit. If any group (a group that controls the number of primary combinations having selections from its group that are permitted to be in a bet unit) could include two or more selections from the same event, then its needs to be established whether the selections would be evaluated separately or as a unit in the primary combination; to achieve this a command for the group could be selected that would instruct that the selections are either evaluated separately or as units of a specified number of selections, or the command for the group could evaluate some criteria before specifying whether the selections are to be considered separately or as a unit (s) in the primary combination. An example of a command could be, “select from the selected participants (the participants selected for groups to produce primary combinations) those with a probability of 11% or greater of winning the event (based on the opening odds of the participants) and the selection with the highest probability is to form a unit with each of the other selections in the event”. This command would make a selection and form units similar to that in group B of table D.

Should the gambler use neither of these last two methods to control the primary combinations used in the production of the bet units, then all possible combinations of the primary combinations would be produced in the bet units.

For a gambler in developing a module of commands, to control the number of primary combinations from the same group that are permitted to be used in producing a bet unit, he would select a command(s) that could assign any of the primary combinations produced to one or more groups (not any of those groups used to produce primary combinations or control the selections in the primary combination of a bet unit) and set the rules for the group(s), the rules for the group determine the range of the number of primary combinations from its group that are permitted to be used in producing a bet unit. An example of a command could be, “if there are more than five and less than twenty primary combinations produced in a leg, then assign those three primary combinations having the lowest sum of the participants probability of winning (based on the current odds) to group A, and if twenty or more primary combinations were produced in a leg then assign those six primary combinations having the lowest sum of the participants probability of winning to group A, set the minimum at zero, and set the maximum at 2 if Group A has primary combinations assigned in 3 legs otherwise set the maximum at 1”. This command applied to the primary combinations in Table E could have resulted in the last six primary combinations in column three of leg one and the last three primary combinations in leg 3 being assigned to group A and a minimum of zero and maximum of 1being set.

There may be other factors that influence whether a wager is to be produced automatically or what selections are to be made, for example, the odds of a participant, the track condition or the number of runners in a race, a command to evaluate these criteria could be applied to a horse, a group, some groups, or all groups. Other data that may need to be entered could include, the period and locations for which the wager is to be taken, how the wager is to be funded, whether the gambler notified of the proposed wager or winnings, whether he needs to approve the wager or is it taken automatically, the gamblers account balance and the minimum and maximum that may be spent on the wager; could be evaluated by commands selected by the gambler.

In producing wagers automatically the gambler could have further control over the bet units produced by including a command in the module of commands which would evaluate all the bet units produced by the automated selection and eliminate those not meeting the command's criteria. For example, a command could be included in a module of commands that produces bet units for a triple trio that instructs, “if two or more primary combinations (trios) in a bet unit include a selection that is ranked fifth or higher then eliminate that bet unit from the wager”.

A module of commands could also be used by the gambler to produce reports; a report would generally be designed to aid the gambler to identify potential wagers and would generally cover the selected games of chance for one day. A gambler may consider many factors before he decides how he will wager, for example the gambler in considering favorites may often look for those that meet certain criteria that he could use as bankers in various bet types, a group could be set up to perform this task of collating favorites that meet the criteria. A gambler would select commands that could evaluate many events (from many venues) and assign participants meeting the criteria to this group, it would not be necessary to set rules for these groups as they are not used to control the production of bet units. Other groups with commands could also be created to collate participants meeting certain criteria, for example participants with certain jockey and trainer combinations, or participants with odds that have changed by a certain percentage, or participants with a drop in weight in will carry for a race, or a selected tipsters recommendations. Groups previously set up to produce wagers automatically, could also be selected to be included in the report. It would be possible for the same participant to be assigned to, and displayed in more than one group. When the gambler wanted to review a report on the games of chance he would be able to recall the module of commands and be able to select the games of chance for evaluation and request that the report be displayed in a desired format. The report could have one of many different formats, for example it could be laid out showing each venue separately with a list of groups that have selections and alongside in columns, each event with its selections listed alongside its group, or a chronological list of the day's events and alongside each event a list of the bet types offered and alongside each bet type a list of the groups and its selections that are applicable to that bet type. Any data that pertains to the event, group or selection could be included in the report, such as the race distance, race grade, group descriptions, groups' rules or selection criteria, the participants: number, name, odds, or speed rating. The format of one or more reports could have been developed by the gambler in the module of commands, or the bet operator could have standardized reports which would display the information produced by any gambler's module of commands.

An alternative is to have different preformatted modules of commands for different scenarios and bet types that the gambler could select and if required adjust the commands and criteria. For example a module for a Pick 4 could be for when the turf conditions are not firm, or when many legs have weak favorites; a gambler who was looking for wagers that may produce higher dividends would then be able to select these modules of commands, adjust them and set his own criteria. When the module of commands was adjusted to the gamblers satisfaction then any event (s) offering this bet type, could be evaluated against the module of commands to see if any bets or reports are produced. These preformatted module of commands could be developed by the bet operator or another entity such as a tipster for the gambler to select and if required to add or change commands and adjust criteria.

Modules of commands to automatically produce wagers or reports could also be developed by a computer analyzing a gambler's betting patterns and selection criteria, then develop a module of commands that would follow similar patterns and use similar selection criteria, the reports and proposed wagers produced by the module of commands would be available for the gambler to review; the gambler could also adjust the module of commands.

Modules of commands are generally designed to evaluate forthcoming events but are also capable of evaluating events that have already been run, this would enable a gambler to use a module of commands to evaluate many previously run races and produce a report showing the imaginary wagers produced, the race results and the dividends paid, to determine a theoretical profit or loss that could have been generated.

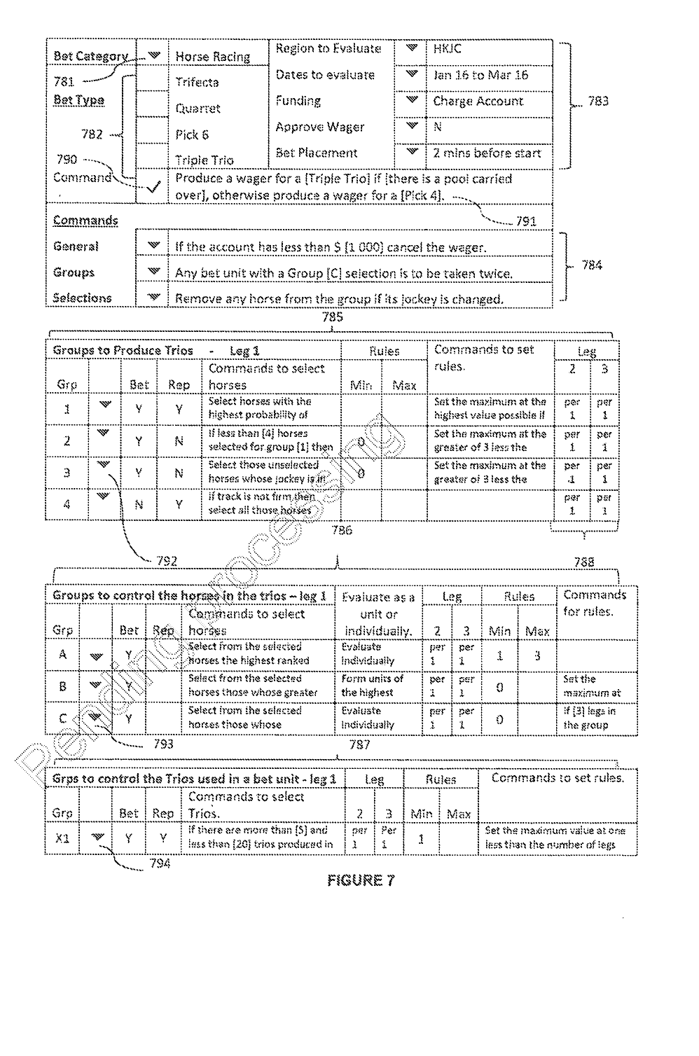

With reference to FIG. 7, an automated wagering template for facilitating the construction of an automated wagering module of commands by a gambler, in accordance with embodiments of the invention, is generally described with reference to numeral 700.

The automated wagering template 700 is presented to the gambler by any electronic means such as a computer terminal, laptop, note pad, smart phone or similar device. The automated wagering template is used by a gambler to produce a module of commands that would generate wagers automatically on behalf of the gamblers. The automated wagering template is split into four parts, the top part comprises four areas as shown by references 781,782, 783 and 784. Part 785 of the automated wagering template 700 aids the gambler in creating a set of groups that would produce the trios (primary combinations) that are used in constructing the bet units. Part 786 of the automated wagering template 700 aids the gambler in creating a set of groups that control the number of primary combinations including horses from a group that maybe used in constructing the bet units. Part 787 of the automated wagering template 700 aids the gambler in controlling the number of trios from a group that maybe used in constructing the bet units.

Once the gambler has indicated that he wishes to create a module of commands to produce wagers automatically he will be able to select the category of the games of chance using the down arrow 781, on selecting the category of the game of chance then area 782 will be displayed to enable him to select the bet type for which he wants to create a module of commands. In area 782 he enters a tick mark 790 to select the bet type, tick mark 790 indicates that he wants the bet type to be determined by a command, this will produce a menu of multiple commands from which the gambler must select one and then adjust the variables in the command. Reference 791 displays the command and variables the gambler has selected, in this example the gambler has indicated he wishes to produce a triple trio if a certain condition is meet otherwise to produce a Pick 4. On entering the selected command 791, then areas 783, 784, 785, 786 and 787 will be displayed to the gambler to enable him to continue developing the module of commands for the triple trio bet type, areas 783, 784, 785, 786 and 787 will include input fields and commands and criteria appropriate to the bet type he is creating the module of commands for. In the automated wagering template 700, the areas required to develop the part of the module to produce a triple trio wager are displayed, (the part of the automated wagering template to produce the Pick 4 is not displayed, but if it was it would be similar to part 786 to enable the gambler to develop groups that would produce bet units for the Pick 4).

Down arrow 792 is selected by the gambler to enable him to complete the input fields to the right of the down arrow 792 which are the input fields to develop group 3. The first input fields to the right of down arrow 792 in the column headed “Bet” enables the gambler to select whether or whether not the group is to be used in producing the wager. The next input field in the column headed “Rep” is where the gambler indicates whether or whether not the group is to be included in any reports produced. The next input field in the column headed “Commands to select horses” is where the gambler selects a command that will select horses meeting the correct criteria for group 3. The next two input fields under the heading “Rules” is where the gambler enters the range of the number of horses from group 3 that must be used in producing the trios by entering a value in the “Min” and “Max” columns. The next input field in the column headed “Commands to set rules” is where the gambler selects a command (s) if he has not entered a value for either the minimum or maximum shown in the “Rules” columns, the selected command will then determine what the minimum and/or maximum values are to be based on the criteria in the command. Reference 788 is where the gambler has access to complete the input fields for leg 2 and/or leg 3 should he not wish to use the same commands and rules as selected for leg 1, otherwise he can indicate from which legs the commands and rules will be the same.

Down arrow 7934 is selected by the gambler to enable him complete the input fields to the right of down arrow 7934. An additional column headed “Evaluate as a unit or individually”, enables the gambler to instruct whether the selected horses are to be considered individual or as a unit with other selected horses from the same leg in a trio, when the bet unit is being evaluated by the groups rules to determine whether or not the number of trios containing selections from the group is permitted in the bet unit.

Down arrow 7942 is selected by the gambler to enable him to complete the input fields to the right of the down arrow 7942.

It will be appreciated that the gamblers input in FIG. 7 is transmitted to the bet operators central processing unit when he selects to save the module of commands, the input data is saved to the computer systems memory element, and a link or reference to the module of commands is provide to the gambler to enable him to recall and edit the module of commands at a later stage.

The bet operator updates his data base with the event (s) that are available to the gamblers for gaming activities. Data input by the bet operator will include the category of games of chance the events belong to, the region, the date and time of the event, the grade of the event, the distance of the event, the participants in the event, data on the participants such as, its draw, its jockey and trainer, the weight it will carry, the participants past race results, its performance rating under different turf conditions and the participant's odds. For the event (s) he will indicate what bet types are available to the gambler. Periodically the data will be updated with any changes such as scratchings, turf conditions, and the participant's odds.

In the following description the numbers in the brackets refer to FIG. 7 and a R refers to the row number and a C to the column number. A module of commands will evaluate what category of games of chance cover the events that have been made available for wagering are from, and if the events are in the chosen category (781) then determine if the events are from the selected region (783 R1) and if the events fall within the selected date range (783 R2), the module of commands will then determine if the bet type that was selected (782) (or selected by a command (790)) is available for the event, and if the bet type is available the module of commands will evaluate each event in turn and a produce a wager as described below.

Firstly, the instructions in (785) are used to produce the trios in each leg. The selected commands (785 C5) evaluate the participants in a leg and assign those participants to the respective groups (785 C1) if the commands criteria are meet, and then establish the rules for the groups by a command (785 C8) if the gambler did not predetermine the minimum and maximum rules for the groups (785 C6 and C7). If any selected command (785 C5) needs to evaluate criteria closer to the start time of the event before a selection can be made and/or the rules can be established, then the module of commands will evaluate the criteria at the stipulated time (alternatively a provisional selection could be made and then re-evaluated at the stipulated time). Then the trios for each leg would be produced by combining from a group the required number of horses as determined by its rules, with each of the other groups required number of horses as determined by their rules to produce units of horses, all those units produced with three horses in it would then form the trios (primary combinations).

Secondly, bet units are created from the trios created in the previous paragraph by combining each trio in leg one with each one of the trios from leg two, and then each of these combinations of two trios is combined with each trio from leg three to form bet units of three trios.

Thirdly, the instructions in (786) are processed to control the number of trios including horses from a group that can be used in producing the bet units. The selected commands (786 C5) evaluate those participants selected by the commands in (785 C5) that are to be used in producing the trios and then assigns those participants meeting any groups criteria to the group, the groups rules are then established by a selected command (786 C11) if not set by the gambler (786 C9 and C10). Then the bet units produced in the second step are evaluated by each of the just mentioned group rules, and those bet units that have more or less trios including selections (or units of selections (786 C6)) from a group than is permitted by the group's rules are eliminated.

Fourthly, the instructions in (787) are processed to further control the number of trios from a group that are permitted to be included in a bet unit. The selected commands (787 C5) evaluating the trios produced by (785) and assign those trios meeting the command's criteria to its group, then rules for the group are established by a command (787 C10) if no rules were set (787 C6 and C7) by the gambler. The bet units not yet eliminated (in the third step) are evaluated by the just mentioned group's rules, and if it there are more or less trios from the group in the bet unit than is permitted by the group's rules then the bet unit is eliminated.

Finally, the commands in (784) are processed and the wager is adjusted if required by the commands. A bet slip is produced of the wager for the gambler, and if the gambler has selected that he needs to approve (or be informed of) the wager (783 R4), then the gambler will be notified (e.g. by SMS, email, or on his account) of the proposed wager. At the time the bet has been selected to be placed (783 R5), it will be submitted to the bet operator.

Relative Performance Gambling

In the prior description it was demonstrated that in using the invention, the gambler is able to control precisely the selections that with be included in each and every bet unit in a wager and was also able to control the number of times any of these bet units was taken; the invention therefore provides a system for the gambler to be rewarded for the correctness of the selections in each and every bet unit of his wager relative to the correctness of the selections in each and every bet unit of all the gamblers. The reward for the gambler would then be a fraction of the pool calculated by dividing the gambler's total number of correct selections (or score) in ever bet unit, by the tally of all the gamblers total number of correct selections (or score) in every bet unit. Wagering based on this reward system will be referred to as “relative performance gambling”.

Various methods could be implemented in relative performance gambling to vary the reward that would be paid out. One variation would be to reward a gambler additional points for subsequent correct selections in a bet unit, for example the first correct prediction in a bet unit could be awarded 1 point, the next correct prediction could be awarded 1.1 points and the next correct prediction could be awarded 1.2 points and so on, then the points awarded in all the bet units in the wager would be totaled to produce a score for each gambler. Another variation would be to offer a greater reward for predicting outsiders to win as opposed to predicting favorites to win; one method to achieve this would be to use the odds as a basis in determining the reward; for example if a gambler correctly predicted a horse with odds of 2/1 he would then be awarded 2 points, with odds of 8/10 then 0.8 of a point would be awarded and 10/1 then 10 points would be awarded. Another variation would be to use the horse's ranking (based on its odds or some other factor) to determine the reward; for example, where the third ranked horse wins then 3 points would be awarded, where the fifth ranked horse wins then 5 points would be awarded. Another variation to the reward system to vary the amount of the reward would be to eliminate a number of gamblers from the pool by either eliminating a preset percentage of the gamblers having the lowest score, or eliminating those that do not have a certain percentage of correct selections, or those whose score is less than a specified amount.

In implementing relative performance gambling the bet operator would merely have to make provision for the gambler when he submits the wager to indicate whether the wager is to be included in the traditional pool, and/or in the “relative performance gambling” pool.

In “relative performance gambling” separate pools each with a different risk and reward level could be offered to the gambler, he could select one or more of the risk and reward levels he wished to play and then when he submits the bet it would be submitted into the one or more of the pools he had selected. The risk and reward levels could be based on either, a different point structures for correct selections in each pool (for example one pool could offer a 50% increase in the value of points awarded for subsequent correct selections in a bet unit and another pool could offer a 100% increase in the value of points awarded for subsequent correct selections in a bet unit), or the number or percentage of gamblers that would be eliminated from each pool (for example, 50% of gamblers with the lowest percentage of correct selections will be eliminated in one pool, and 25% of the gamblers with the lowest percentage of correct selections be eliminated in another pool).

“Relative performance gambling” is suited to bet types that occur over many legs so would be suited to being adapted into a game of chance that would cover all, or many of the races at a race meeting. As it is not necessary to have a winning selection in every leg to win a prize, a variation would be to allow the gambler to only make selections in those legs he wishes to. Bet units produced on present day systems are also capable of being evaluated on a relative performance gambling basis.

Financial Games of Chance

Using the same principals as described in the previous sections, the invention can be adapted to providing financial games of chance to investors. Financial games of chance could be created by using the same formats as any bet type; for example the format of a Triple Trio could be used, where the investor would have to predict from three sets of financial instruments, the top three performing financial instruments in each set. Groups and rules could be used with these new games to allow the investor more control when making selections. The reward could be based on an absolute or relative basis. As the best method to gauge the performance of a financial instrument is to evaluate its percentage change in value relative to the average percentage change in value of the other financial instruments over a period of time, then the best method to reward an investor would be to determine the percentage difference between the average percentage change in value of the investor's selected financial instruments and the average percentage change in value of each and every investor's selected financial instruments (over the same time period) and use this percentage difference as a basis for the reward. This percentage difference will be referred to as the “relative performance percentage”, it uses the same principles as mentioned previously in “relative performance gambling”. The amount of the reward (or loss) would be calculated by either multiplying the investors's “relative performance percentage” by the amount of the agreed investment or stake, or a percentage point could have been set at a predetermined amount, for example a relative performance percentage gain of one percent would result in a hundred dollar reward. Those investors who had performed above average, would be rewarded by those investors who had performed below average. Different risk/reward level's each with its own pool could be provide by the bet operator, for each level the “relative performance percentage” could be increased a different number of times (or decreased by a percentage); for example in one pool the investors “relative performance percentage” would be doubled when determining the amount of the reward, and in another pool the “relative performance percentage” could be trebled (or reduced by fifty percent) in determining the amount of the reward. The investor would then be able to select one or more levels to submit his selections into.

An example of such a financial game of chance is shown in table G, groups and rules are provided, and the investors's reward is based on the performance of his selections relative to the performance of all the investor's selections. Table G displays one investors selections; three sets of financial instruments have been provided, their columns headed “Index”, “Cmdty” and “Forex” (financial indexes, commodities, and foreign exchanges), and groups and rules are provided in the lower part of table G. In making his selections the investor may assign any number of financial instruments from each set to either group A or group B, and then set rules for each group. Each set of financial instruments having selections in the game will produce a “relative performance percentage” for the investor which would be used to base the reward on. In table G the selections made by an investor, have been made by placing the letter of the group it was assigned to next to the selected financial instrument in the “Grp” column, and the minimum and maximum rules as set by the investor are shown in the bottom part of table G, (only a small sample of financial instruments have been used in table G, the actual game would offer more financial instruments for selection).

TABLE G
Investor 1

| | Index | Grp | Cmdty. | Grp | Forex | Grp |
|---|---|---|---|---|---|---|
| | FTSE 100 | A | Gold | | EUR/USD | |
| | DAX 30 | B | Platinum | A | EUR/GBP | |
| | CAC 40 | B | Silver | A | EUR/JPY | |
| Group A | Min | 1 | Min | 1 | Min | 0 |
| | Max | 1 | Max | 1 | Max | 0 |
| Group B | Min | 0 | Min | 0 | Min | 0 |
| | Max | 1 | Max | 0 | Max | 0 |

Some variations that may be implemented in the above game of chance; as there are different sets of financial instruments that each produce a “relative performance percentage” then either the sum or the average of the “relative performance percentages” from the different sets of financial instruments could be used to reward the investor. The investor does not have to make a selection from all the sets of financial instruments and they could exit and reenter the game when they wish. A date and time could be set for the game of chance to end, or the game of chance could continue indefinitely with period ends set so investors could be rewarded or settle their losses.

An option could be made available for the investor to apply a command to a selected financial instrument, a group of selections or all groups that if a criteria's condition is meet then selections of the financial instrument are changed (s), and/or the groups and rules are changed; for example if the FTSE increases by 2% then the platinum selection must be cancelled and the EUR/USD exchange rate must be selected, or if the Dow Jones Industrial Average falls by 10% then clear all selections, (or set the minimum and maximum to zero for all groups).

With the financial games it would be possible to include other features in the invention such as increasing the number of times certain investment combinations are taken, or having investments combinations produced automatically by modules of commands.

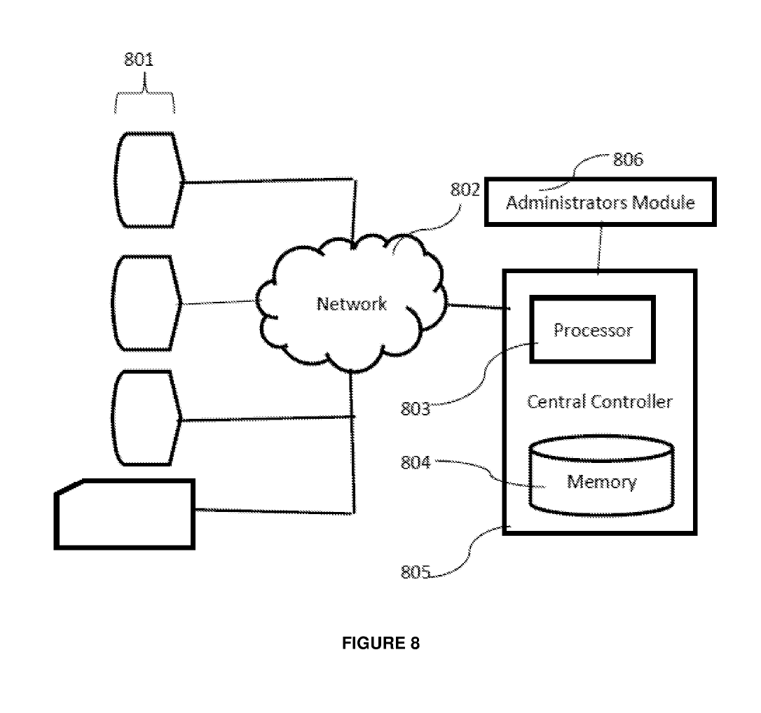

With reference to FIG. 8 a computer system for a gaming system that allows wagers to be produced, in accordance with embodiments of the invention, is generally described with reference to numeral 805.

The user interface 801 requires any device such as a computer, notebook, mobile device, telephone, remote terminal (self-service or assisted), card reader, printers or television suitable to facilitate communication with the bet operator's central computer system 805. The user interface 801 may be in the form of a software application on a mobile computing device of a user, etc. operable to direct the users to the system 805. Instead, or in addition, the user interface 801 may be in the form of a web page hosted by the system 805 and may be accessible by the users. The system 805 may be hosted on a server, a plurality of networked servers, or the like, so as to provide the functionality as described herein to the user.

The system 805 may be integrated with a bet operator computer system so as to generate and place wagers for users. Instead, or in addition, the system 805 may be a stand alone system operable to transmit wagers generated thereby to the bet operators for placement in a conventional fashion.

The communications network 802 could be any area network such as LAN, WAN, WLAN, VPN, an old telephone system, or any system capable of handling data. The gambler may enter the selections and commands directly into the computer system using the user interface 801, or he may enter the selections and commands onto a mark sense card which is then read by a card reading device, alternatively he could be assisted by a computer terminal operator. The central computer system 805 includes one ore more processors 803 and memory 804, for example, a database which are administered by the administrator's module 806. Memory 804 is utilized to store data, for example, client profiles, gamblers selections, racing data, financial data, results data and processing programs. The processor 803 is configured to provide data to the user interface 801, receive data as hereinbefore described from users, produce wagers as determined by the gambler in a fashion described herein, handle racing and related data, comparing gamblers wagers to race results and accounting for any such transactions.

In this regard it will be noted that the processor 803 may comprise one or more modules which correspond to the functional tasks performed by the system, for example, the module of commands. In this regard, “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device but may be spread across a plurality of devices, for example, across the network 802 to provide functionality as described herein.

In one example embodiment, the memory or database 804 may store a plurality of user profiles and/or accounts associated with users of the system 805, wherein the user profiles store financial data associated with users, for example, account balances etc. The system 805 may be configured to debit and credit the accounts of the users in response to wagers being placed and winnings allocated.

The system 805, particularly the processor 803 may be configured to receive and transmit data via network 802 to the user, particularly control presenting the bet slips as described above thereto, including selections to be made by the user. It will be appreciated that in some example embodiments, the bet slips may be electronic interactive bet slips and may be provided by the module 801. The module 801 transmits data received via the bet slips to the processor 803 via the network 802. The processor 803 is configured to process the data received, i.e., the user selections from the bet slip to generate wagers and/or bet units in a fashion as aforedescribed. It will be appreciated by those skilled in the field of invention that the system 805 may be configurable to perform any of the processes as described above.

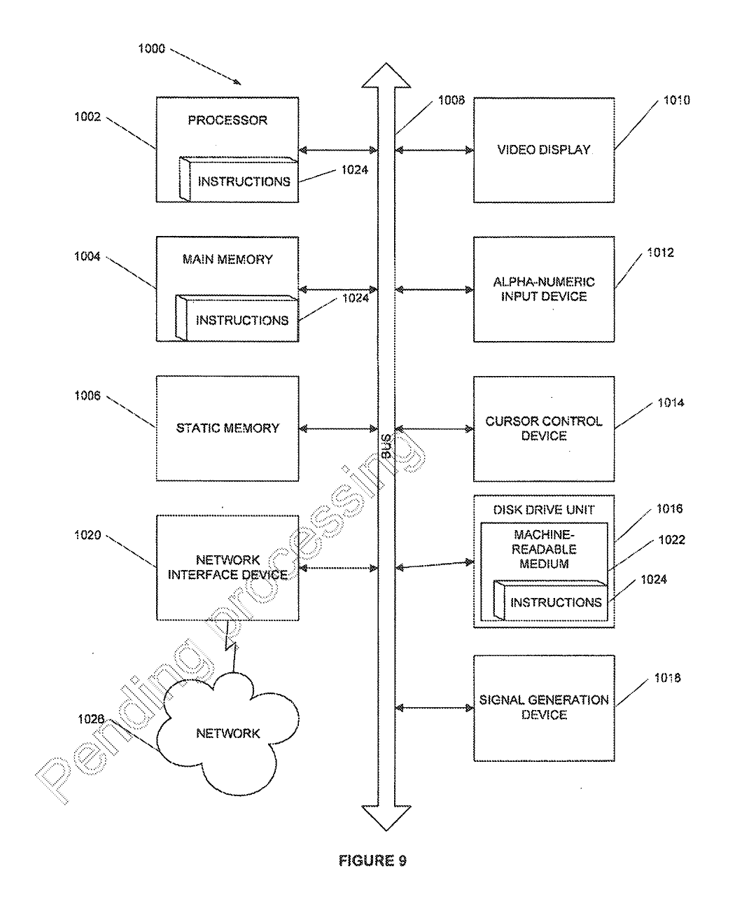

FIG. 9 shows a diagrammatic representation of machine in the example of a computer system 1000 within which a set of instructions, for causing the machine to perform any one or more of the methodologies and/or example embodiments of the invention discussed herein, may be executed. In other example embodiments, the machine operates as a standalone device or may be connected (e.g., networked) to other machines. In a networked example embodiment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated for convenience, the term “machine” shall also be taken to include any collection of machines, including virtual machines, that individually or jointly execute a set (or multiple sets) of instructions to perform any one or more of the methodologies discussed herein.

In any event, the example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse, or touchpad), a disk drive unit 1016, a signal generation device 1018 (e.g., a speaker) and a network interface device 1020.

The disk drive unit 1016 includes a machine-readable medium 1022 storing one or more sets of instructions and data structures (e.g., software 1024) embodying or utilised by any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020 utilising any one of a number of well-known transfer protocols (e.g., HTTP).

Although the machine-readable medium 1022 is shown in an example embodiment to be a single medium, the term “machine-readable medium” may refer to a single medium or multiple media (e.g., a centralized or distributed database, and/or associated caches and servers) that store the one or more sets of instructions. The term “machine-readable medium” may also be taken to include any medium that is capable of storing, encoding or carrying a set of instructions for execution by the machine and that cause the machine to perform any one or more of the methodologies of the present invention, or that is capable of storing, encoding or carrying data structures utilised by or associated with such a set of instructions. The term “machine-readable medium” may accordingly be taken to include, but not be limited to, solid-state memories, optical and magnetic media, and carrier wave signals.

In the preceding description examples have mainly been of horse racing or football pools, the invention is suitable for any game of chance requiring multiple selections. In describing the invention preferred embodiments have been shown, various modifications and substitutions may be made thereto without departing from the spirit of the invention. Accordingly, the invention has been described by way of illustration and not limitation. The invention as described herein is simple to understand and implement, that does not affect a gambler who wants to continue using traditional methods of wagering, and opens up new possibilities in developing new games of chance, it would be of great value to the gambling industry. The invention as described herein allows the gambler to select bet units or combinations of selections (that produce bet units) for elimination whereas in conventional systems, this is tedious and time consuming to achieve.

The systems described herein also reduces the amount of betting sheets or mark sense cards have to be filled in by users and processed by bet operators thus saving resources and freeing up a gambler time such that they may be able to place bets in time as opposed to spending numerous hours to generate their wager.

1. A system for facilitating wagering, the system comprising:
a database storing data; and
a processor configured to:
receive, from a user, a selection of a bet type for one or more events having uncertain outcomes;
receive a selection, from the user, of bet elements associated with the one or more events having uncertain outcomes;
receive information indicative of an allocation of the received selection of bet elements to one or more groups;
receive a selection, from the user, of one or more criteria to apply to the one or more groups, wherein the one or more criteria comprise one or more rules for application to the one or more groups;
allocate the selected bet elements to one or more groups in accordance with the received information indicative of the allocation, and store the allocations in the database;
apply one or more selected criteria to the one or more groups to generate one or more bet units which conform substantially to the one or more criteria; and
generate a wager comprising at least some of the one or more conforming bet units.

2. A system as claimed in claim 1, wherein the processor is configured to:
store the received rules in the database; and
apply the stored rules to the one or more groups to generate one or more bet units in accordance with the selected bet type, wherein the generated bet units conform substantially to or are in accordance with the one or more rules;
prompt the user for a selection of the one or more generated bet units and/or combinations of bet units;
receive a selection of the one or more generated bet units and/or combinations of bet units from the user; and
generate the wager comprising the selected one or more generated bet units.

3. A system as claimed in claim 2, wherein the one or more rules applied by the processor enables the processor to control the number of occurrences of a bet element, from a group, in a bet unit.

4. A system as claimed in claim 1, wherein the processor is configured to:
receive a selection of, or determine one or more criteria to apply to the bet elements and/or groups, wherein the one or more criteria comprises one or more commands;
store the commands in the database;
apply the stored commands to one or more of the selected bet elements, and/or groups, and generate one or more bet units which conform substantially to or are in accordance with the one or more commands; and
generate the wager comprising the one or more conforming bet units.

5. A system as claimed in claim 4, wherein the one or more commands applied by the processor enables the processor to control the occurrence of a bet unit in the wager.

6. A system as claimed in claim 1, wherein the processor is configured to:
receive a selection of a plurality of bet elements, wherein the bet elements are associated with a plurality of events;
receive information indicative of the allocation of the received selection of bet elements to the one or more groups;
receive a selection of one or more criteria to apply to the one or more groups, wherein the one or more criteria comprise at least one or more rules for application to the one or more groups; and
apply the one or more rules to the one or more groups to generate one or more primary combinations in each event of the plurality of events, wherein each primary combination comprises multiple bet elements for the event which substantially conform to the one or more rules.

7. A system as claimed in claim 6, wherein the processor is configured to:
generate a bet unit which comprises a primary combination in each of the plurality of events; and
generate the wager comprising one or more bet units.

8. A system as claimed in claim 6, wherein the processor is configured to:
prompt a user for a selection of the one or both of combinations of primary combinations and/or the generated bet units;
receive a selection of the one or both of combinations of primary combinations and/or the generated bet units from the user; and
generate the wager comprising the selected one or both of combinations of primary combinations and/or the generated bet units.

9. A system as claimed in claim 6, wherein the one or more rules applied by the processor enable the processor to control one or more of:
the number of occurrences of bet elements, from a group, in a primary combination;
the number of occurrences of primary combinations in a bet unit permitted to have bet elements from a group; and
the number of occurrences of primary combinations from a group comprising primary combinations to be included in a bet unit, wherein the user selects the primary combinations to be allocated to the group.

10. A system as claimed in claim 6, wherein the processor is configured to enable a user to select, when a bet element selected is assigned to a group, whether the one or more rules associated with the group is to consider of the bet elements individually or as a unit with one or more other bet elements in the same primary combination, when determining the number of primary combinations in a bet unit permitted to have selections from a group.

11. A system as claimed in claim 6, wherein the one or more criteria comprises one or more commands, wherein the processor is configured to apply the one or more commands to the one or more of the selected bet elements, groups, bet units, and primary combinations to generate bet units for the wager conforming substantially to the one or more commands.

12. A system as claimed in claim 4, wherein the one or more commands applied by the processor enables the processor to control whether the wager is taken as one or both of a pooled and fixed odds wager.

13. A system as claimed in claim 1, wherein the one or more criteria comprise one or more commands, wherein the processor is configured to receive and execute a command for any bet element or any group of bet elements, wherein upon execution of the command, the processor is configured to determine that should certain parameters be met at a specified time or during any specified time period before a close of a betting window associated with the wager, the processor is configured to remove bet element/s from the group, transfer bet element/s to another group, change the rules for any group, remove other bet element/s from groups, transfer other bet elements to other groups, add bet element/s to groups, change or select whether any bet unit is taken as a pooled bet and/or fixed odds bet and the number of times any bet units are to be taken.

14. A system as claimed in claim 1, wherein the processor is configured to:
receive one or more of historic data indicative of outcomes of one or more events, previous selections of criteria, previous selections of bet elements, and bet units:
use the received historic data to generate a module of commands; and
use the module of commands to automatically allocate the bet elements, apply the one or more criteria, and generate the wager.

15. A system as claimed in claim 1, wherein the system comprises a bet operator interaction module operable to interface the system with a bet operator such that the generated wager is transferred to the bet operator via the bet operator interaction module to be placed by the bet operator.

16. A system as claimed in claim 1, wherein the system forms part of a bet operator computing system.

17. A system as claimed in claim 1, wherein the processor is configured to:
receive a selection of a category of games of chance;
receive a selection of one or more groups;
receive a selection of criteria in the form of command/s for each group to evaluate all bet elements in the form of participants in one or more events in the selected category of games of chance and assign those participants substantially in conformity or in accordance with the selected commands to the group;
receive a selection of those groups for which the group's selected participants must be displayed to a user and the format in which to display the information;
receive a selection of a bet type;
receive a selection of criteria in the form of rule/s for each group that determines the range of the number of positions in a bet unit that participants from its group are permitted to be in;
receive a selection of a command that would evaluate a category of games of chance and enable selection of a pre-selected bet type, pre-selected commands, pre-selected group structure and/or pre-selected groups rules;
receive a selection of a command that would evaluate one or more other groups selections and/or rules in determining what participants to assign to the said group;
receive a selection of a command that would evaluate one or more other groups selections and/or rules in determining the rules for the said group;
receive a selection of a command that determines if a condition is met at a specified time or during any period of time prior to the betting closing whether the selection is removed from the group or transferred to another group, one or more other selections are remove from groups or transferred to another group, one or more new selections are assigned to groups, and/or the rules for any group are changed;
receive a selection a command that determines if a selection meets certain requirements whether any bet unit including the said selection is to be taken as a pooled bet and/or as a fixed odd bet and the number of times any bet units can be taken;
receive art instruction to store one or more of the selected commands in a module
store the module of commands in the database; and
operate the module of commands module to generate the wager which substantially conforms or is in accordance with the commands stored in the module of commands.

18. A method of operating a system for facilitating wagering, the method comprising:
maintaining a database;
receiving, from a user, a selection of a bet type for one or more events having uncertain outcomes;
receiving a selection, from the user, of bet elements associated with the one or more events having uncertain outcomes;
receiving information indicative of an allocation of the received selection of bet elements to one or more groups;
receiving a selection, from the user, of one or more criteria to apply to the one or more groups, wherein the one or more criteria comprise one or more rules for application to the one or more groups;
allocating the selected bet elements to, the one or more groups and storing the allocations in the database;
applying one or more criteria to one or both of the selected one or more bet elements and the one or more groups to generate one or more bet units which conform substantially to the one or more criteria; and
generating a wager comprising at least some of the one or more conforming bet units.

19. A method as claimed in claim 18, wherein the method comprises:
receiving a selection of a bet type for one or more events having uncertain outcomes;
storing the rules in the database;
applying the stored rules to the one or more groups to generate one or more bet units in accordance with the selected bet type and storing the generated bet units in a database, wherein the one or more generated bet units conform substantially to the one or more rules;
prompting the user via an input/output device for a selection of the one or more generated bet units and/or combinations of generated bet units;
receiving a selection of the one or more generated bet units and/or combinations of generated bet units from the user; and
generating the wager comprising the selected one or more generated bet units.

20. A method as claimed in claim 18, wherein the method comprises:
receiving a selection of, or determining one or more criteria to apply to the bet elements and/or groups, wherein the one or more criteria comprises one or more commands;
storing the commands in the database;
applying the stored commands to one or more of the selected bet elements, and/or groups, and generating one or more bet units which conform substantially to the one or more commands; and
generating the wager comprising the one or more conforming bet units.

21. A method as claimed in claim 18, wherein the method comprises:
receiving a selection of a plurality of bet elements, wherein the bet elements are associated with a plurality of events;
receiving information indicative of the allocation of the received selection of bet elements to the one or more groups;
receiving a selection of one or more criteria to apply to the one or more groups, wherein the one or more criteria comprise at least one or more rules for application to the one or more groups; and
applying the one or more rules to the one or more groups to generate one or more primary combinations in each event of the plurality of events, wherein each primary combination comprises multiple bet elements for the event which substantially conform to the one or more rules.

22. A method as claimed in claim 21, wherein the method comprises:
generating a bet unit which comprises a primary combination in each of the plurality of events; and
generating the wager comprising one or more bet units.

23. A method as claimed in claim 22, wherein the method comprises:
prompting a user for a selection of the one or both of combinations of primary combinations and/or the generated bet units;
receiving a selection of the one or both combinations of primary combinations and/or the generated bet units from the user; and
generating the wager comprising the selected one or both of combinations of primary combinations and/or the generated bet units.

24. A method as claimed in claim 18, wherein the method comprises:
receiving one or more of historic data indicative of outcomes of one or more events, previous selections of criteria, previous selections of bet elements, and bet units:
using the received historic data to generate a module of commands; and
using the module of commands to automatically allocate the bet elements, apply the one or more criteria, and generate the wager.

25. A method as claimed in claim 18, wherein the method comprises:
receiving a selection of criteria from a user, wherein the criteria comprises one or more rules and commands;
storing the received selection of criteria in the database in a module of commands; and
using the module of commands to automatically generate the wager.

26. A method as claimed in claim 18, comprising the steps of:
receiving, from a user, a selection of a category of games of chance;
receiving, from the user, a selection of one or more groups;
receiving, from the user, a selection of criteria in the form of command/s for each group to evaluate all bet elements in the form of participants in one or more events in the selected category of games of chance and assign those participants substantially in conformity or in accordance with the selected commands to the group;
receiving, from the user, a selection of those groups for which the group's selected participants must be displayed to the user and the format in which to display the information;
receiving, from the user, a selection of a bet type;
receiving, from the user, a selection of criteria in the form of rule/s for each group that determines the range of the number of positions in a bet unit that participants from its group are permitted to in;
receiving, from the user, a selection of a command that would evaluate a category of games of chance and enable selection of a pre-selected bet type, pre-selected commands, pre-selected group structure and/or pre-selected groups rules;
receiving, from the user, a selection of a command that would evaluate one or more other groups selections and/or rules in determining what participants to assign to the said group;
receiving, from the user, a selection of a command that would evaluate one or more other groups selections and/or rules in determining the rules for the said group;
receiving, from the user, a selection of a command that determines if a condition is met at a specified time or during any period of time prior to the betting closing whether the selection is removed from the group or transferred to another group, one or more other selections are remove from groups or transferred to another group, one or more new selections are assigned to groups, and/or the rules for any group are changed;
receiving, from the user, a selection of a command that determines if a selection meets certain requirements whether any bet unit including the said selection is to be taken as a pooled bet and/or as a fixed odd bet and the number of times any bet units can be taken;
receiving, from the user, an instruction to store one or more of the selected commands in a module of commands;
storing the module of commands in the database; and
operating the module of commands module to generate the wager which substantially conforms or is in accordance with the commands stored in the module of commands.

27. A non-transitory computer-readable medium comprising a set of computer executable instructions which when operated by a computer system, causes the same to:
receive, from a user, a selection of a bet type for one or more events having uncertain outcomes;
receive a selection, from the user, of bet elements associated with the one or more events having uncertain outcomes;
receive information indicative of an allocation of the received selection of bet elements to one or more groups;
receive a selection, from the user, of one or more criteria to apply to the one or more groups, wherein the one or more criteria comprise one or more rules for application to the one or more groups;
allocate the selected bet elements to one or more groups and store the allocations in the database;
apply one or more criteria to one or both of the selected one or more bet elements and the one or more groups to generate one or more bet units which conform substantially to the one or more criteria; and
generate the wager comprising at least some of the one or more conforming bet units.

28. A non-transitory computer readable medium system as claimed in claim 27, wherein the instructions cause the computer system to configured to:
receive a selection of a bet type for one or more events having uncertain outcomes;
apply the one or more rules to the one or more groups to generate one or more bet units in accordance with the selected bet type, wherein the generated bet units conform substantially to or are in accordance with the one or more rules;
prompt the user for a selection of the one or more generated bet units and/or combinations of generated bet units;
receive a selection of the one or more generated bet units and/or combinations of generated bet units from the user; and
generate a wager comprising the selected one or more generated bet units.

29. A non-transitory computer readable medium as claimed in claim 27, wherein the instructions cause the computer system to:
receive a selection of, or determine one or more criteria to apply to the bet elements and/or groups, wherein the one or more criteria comprises one or more commands;
apply one or more commands to one or more of the selected bet elements, and/or groups, and generate one or more bet units which conform substantially to or are in accordance with the one or more commands; and
generate the wager comprising the one or more conforming bet units.

30. A non-transitory computer readable medium as claimed in claim 27, wherein the instructions cause the computer system to:
receive a selection of a plurality of bet elements, wherein the bet elements are associated with a plurality of events;
receive information indicative of the allocation of the received selection of bet elements to the one or more groups;
receive a selection of one or more criteria to apply to the one or more groups, wherein the one or more criteria comprise at least one or more rules for application to the one or more groups; and
apply the one or more rules to the one or more groups to generate one or more primary combinations in each event of the plurality of events, wherein each primary combination comprises multiple bet elements for the event which substantially conform to the one or more rules.

31. A non-transitory computer-readable medium as claimed in claim 30, wherein the instructions cause the computer system to:
generate a bet unit which comprises a primary combination in each of the plurality of events; and
generate the wager comprising one or more bet units.

32. A non-transitory computer readable medium as claimed in claim 30, wherein the instructions cause the computer system to:
prompt the user for a selection of the one or both of combinations of primary combinations and/or the generated bet units;
receive a selection of the one or both of combinations of primary combinations and/or the generated bet units from the user; and
generate the wager comprising the selected one or both of combinations of primary combinations and/or the generated bet units.

33. A system for use in wagering, the system comprising:
a database storing data; and
a processor configured to:
receive a user selection of a category of a game of chance comprising one or more events via a suitable electronic input/output device;
receive a user selection of one or more groups and storing information associated therewith in the database;
receive a user selection of commands for each selected group;
use the selected commands to generate a module of commands and store the same in the database, wherein the module of commands is configured to apply some or all of the selected commands, wherein the application of the commands by the module of commands causes the processor to evaluate one or both of events and bet elements in the form of participants in all or some events relating to the selected category of a game of chance, and if one or more of the participants of the events are substantially in conformity or accordance with the selected commands, assign the one or more participants to the respective group/s; and
receive from the user a selection of events for the module of commands to evaluate.

34. A system as claimed in claim 33, wherein the processor is configured to:
receive a selection of a bet type from the user;
receive a selection from the user of one or both of an existing group or a new group;
receive a selection from the user of a set rules for each selected group that determines a range of the number of positions in a bet unit that selections from a group are permitted to occupy in producing bet units; and
generate a wager automatically based on the commands applied by the module of commands and selected rules.

35. A computer system for wagering, the system comprising:
a memory element storing data; and
a processor comprising a user interface module to facilitate the offering and placement of bets, the processor being configured to:
display information relating to games of chance;
receive via a communication network from users using one or more input devices betting details including:
a selection of a bet type for an event or number of events used in a game of chance;
a selection of a number of the participants from the event or events that would produce at least one bet unit;
an instruction as to which groups the selected participants have been assigned to;
a rule for each group determining the range of the number of positions in a bet unit that selections from its group are permitted to be in;
a command that if a bet unit contains a specified selection with another specified selection then the bet unit is eliminated;
an instruction to display the bet units or the combinations producing the bet units;
a selection of any bet units or combinations producing the bet units that are to be eliminated on placing the bet;
an instruction whether any bet unit including a specified bet element or bet element from a specified group is to be taken as a pooled bet and/or as a fixed odds bet and/or the number of times any bet unit is to be taken;
a command for a bet element or a group of bet element that should it meet certain criteria at a specified time or during any period of time before the betting is closed, that it may be removed from the group, get transferred to another group, change the rules for any group, remove other selections from groups, transfer other selections to another groups, and/or add selections to groups before the bet is placed;
an instruction on whether the bet is funded by cash, card or account;
an instruction to place any bet units not eliminated with the bet operator;
generate and issue of a bet slip to the user; and
store the users betting details in a data base in the memory element of the computer system.

36. A computer system for wagering comprising:
a database storing data; and
a processor configured to:
display information relating to games of chance to a user via a suitable input/output device;
receive, via a communications network, from user's input/output devices:
a selection of a category of games of chance;
a selection of one or more groups;
a selection of a command for each group to evaluate all bet elements in the form of participants in one or more events in the selected game of chance and assign those participants substantially in conformity or in accordance with the selected commands to the group;
a selection of those groups for which the group's selected participants must be displayed and the format in which to display the information;
a selection of a bet type;
a rule for each group that determines the range of the number of positions in a bet unit that participants from its group are permitted to be in;
a selection of a command that would evaluate a category of games of chance and enable selection of a bet type, commands, group structure and/or groups rules;
a selection of a command that would evaluate one or more other groups selections and/or rules in determining what participants to assign to the said group;
a selection of a command that would evaluate one or more other groups selections and/or rules in determining the rules for the said group;
a selection of a command that determines if a condition is met at a specified time or during any period of time prior to the betting closing whether the selection is removed from the group or transferred to another group, one or more other selections are remove from groups or transferred to another group, one or more new selections are assigned to groups, and/or the rules for any group are changed;
a selection of a command that determines if a selection meets certain requirements whether any bet unit including the said selection is to be taken as a pooled bet and/or as a fixed odd bet and the number of times any bet units can be taken; and
an instruction to store one or more of the selected commands in a module of commands;
storing the module of commands in the database; and
operate the module of commands module to generate a wager which substantially conforms or is in accordance with the commands stored in the module of commands.

37. A system as claimed in claim 35, wherein the processor is configured to:
display on a user interface in the requested format those selections from those groups previously identified for the events selected by the user; and
store the users betting details in a data base in the database.
